(19) United States
(12) Patent Application Publication
(10) Pub. No.: US 2025/0013951 A1
(43) Pub. Date: Jan. 9, 2025

(54) SYSTEMS AND METHODS FOR ASSISTING COMPLIANCE BY SCHOOL CERTIFYING OFFICIAL

(71) Applicant: Laezr LLC, Huntington Beach, CA (US)

(72) Inventors: Erik Charles Langslet, Huntington Beach, CA (US); Samuel Philip Draznin, Ranchester, WY (US)

(73) Assignee: Laezr LLC, Huntington Beach, CA (US)

(21) Appl. No.: 18/587,058

(22) Filed: Feb. 26, 2024

Related U.S. Application Data
(60) Provisional application No. 63/448,020, filed on Feb. 24, 2023.

(51) Int. Cl. G06Q 10/0631; G06Q 30/018; G06Q 50/20

(52) U.S. Cl. CPC G06Q 10/063114; G06Q 30/018; G06Q 50/2053

(57) ABSTRACT

A method includes storing information usable to host a platform for managing SCO responsibilities and storing a database of stored data including student information and SCO information. The method also includes accessing the platform using a user device and receiving input corresponding to an action, the action being related to the student information or the SCO information, and the input including any input information required for the platform to perform the action. The method also includes performing the action related to the responsibilities of the SCO and updating at least one of the student information or the SCO information in the stored data based on results of the action. The method also includes generating a log entry in response to performance of the action, storing the log entry in a list of logs, and outputting output data related to completion of the action.

### CROSS-REFERENCE TO RELATED APPLICATIONS

This application claims the benefit and priority of U.S. Provisional Application No. 63/448,020, titled SYSTEMS AND METHODS FOR ASSISTING COMPLIANCE BY SCHOOL CERTIFYING OFFICIAL and filed on Feb. 24, 2023, the entire contents of which is hereby incorporated by reference in its entirety.

### BACKGROUND

### 1. Field

The present disclosure is directed to systems and methods for assisting compliance by school certifying officials (SCOs) and, more particularly, for auditing and standardizing compliance efforts of SCOs.

### 2. Description of the Related Art

Veterans of United States military branches are entitled to free or discounted attendance at some universities and colleges. Universities and colleges must comply with rules established by the Federal Government for the university or college to receive payment from the Federal Government for attendance by veterans. Many of these schools hire school certifying officials (SCOs) to manage attendance by veterans as well as to manage compliance with various rules. The duties and obligations of these SCOs may be varied and eclectic. For example, SCOs may be required to: keep the Department of Veterans Affairs (VA) informed of the enrollment status of veterans; keep the state approving agency (SAA) and VA informed of new programs, changes in programs, and institutional changes; apprise supervisors of any problems which may affect service to veteran students; keep up to date on VA rules and benefits; assist veteran students in applying for education benefits; maintain records of veteran students; and make records available for inspection during audits. If work performed by an SCO fails to comply with the rules and regulations established by the VA, then the university or college may lose the ability to get reimbursed by the Federal Government.

There are presently no operating guidelines that provide instructions for performing these duties, no systems to assist in organization and performance of duties, no systems for ensuring compliance with rules and standardization of records, and no systems to securely store such records. While SCOs are granted freedom in performing their duties, the lack of guidelines and systems presents challenges for SCOs, the VA, and universities and colleges that educate veteran students. These challenges include difficulty in training new SCOs and difficulty with organizing SCO obligations and tasks. The challenges further include the fact that records from different SCOs are stored and presented with differing information and formats, and there is presently a lack of security for SCO records and other documents. Furthermore, the challenges also include difficulty maintaining compliance with rules and record requirements.

Thus, there is a need in the art for systems and methods for increasing the ability of SCOs to comply with rules and regulations, increasing security of SCO records, and standardizing the way SCOs record information and perform their obligations.

### SUMMARY

An exemplary method for managing responsibilities of a school certifying official (SCO), according to the detailed description below, may include storing, on a server, information usable to host a platform for managing responsibilities of the SCO. The method may further include storing, on the server or in a memory, a database of stored data related to the responsibilities of the SCO, and including student information related to a plurality of students assigned to the SCO and SCO information related to the responsibilities of the SCO, the student information including a list of students assigned to the SCO that correspond to the plurality of students assigned to the SCO and student information associated with each student in the list of students, and the SCO information including a list of tasks to be completed by the SCO. The method may further include accessing, by a user, the platform using a user device that is separate from the server and in electrical communication with the server. The method may further include receiving, from the user device, input corresponding to an action to be performed by the platform, the action being related to at least one of the student information or the SCO information, and the input including any input information required for the platform to perform the action. The method may further include performing, by the platform, the action related to the responsibilities of the SCO. The method may further include updating, in the database, at least one of the student information or the SCO information in the stored data based on results of the action. The method may further include generating, by the platform, a log entry in response to performance of the action, and storing the log entry in a list of logs in the database. The method may further include outputting, on the user device, output data related to completion of the action.

In any of the foregoing embodiments, the action includes at least one action from a plurality of actions including: adding or removing at least one student from the list of students assigned to the SCO; changing the student information related to at least one student from the list of students assigned to the SCO; adding or revising a document or note associated with at least one student from the list of students assigned to the SCO, adding or revising a document or note associated with the SCO; or adding or marking as complete a task to be completed by the SCO from the list of tasks associated with the SCO.

In any of the foregoing embodiments, the platform is configured to perform each of the plurality of actions.

In any of the foregoing embodiments, the action includes creating an audit report to include at least a portion of the student information from the database associated with each student in the list of students.

Any of the foregoing embodiments may further include receiving, from the user device, an identifier of information to be included in the audit report, wherein performing the action includes creating the audit report to include the identified information.

Any of the foregoing embodiments may further include receiving, from the user device, format information corresponding to a desired format of the audit report, wherein performing the action includes creating the audit report to have the desired format.

In any of the foregoing embodiments, the student information includes at least one of student grades, classes in which each student is enrolled, scholarships awarded to each student, benefits assigned to each student, a document or note associated with at least one student, a program of study in which each student is enrolled, or a branch of military in which each student served.

In any of the foregoing embodiments, the SCO information includes at least one of the list of tasks to be performed by the SCO, a document or note associated with the SCO, or a calendar with a plurality of calendar entries associated with the SCO.

Any of the foregoing embodiments may further include: identifying, by the platform, a priority of each task from the list of tasks based on information associated with each task; and ordering, by the platform, the list of tasks based on at least one of the identified priority or a due date of each task.

Any of the foregoing embodiments may further include: detecting, by the platform, a trigger event corresponding to a specific event; and automatically generating and sending, by the platform, an email having a predetermined format and content identified by the SCO in response to detection of the trigger event.

Any of the foregoing embodiments may further include automatically generating and sending, by the platform, an email having information corresponding to an open task and a due date of the open task when the due date of the open task is at least one of the present day or a previous day, wherein the list of tasks includes a due date and a status for each task.

Also disclosed is a method for managing responsibilities of a school certifying official (SCO). The method includes storing, on a server, information usable to host a platform for managing responsibilities of the SCO. The method further includes storing, on the server or in a memory, a database of stored data related to the responsibilities of the SCO, and including student information related to a plurality of students assigned to the SCO and SCO information related to the responsibilities of the SCO, the student information including a list of students assigned to the SCO that correspond to the plurality of students assigned to the SCO and student information associated with each student in the list of students, and the SCO information including a list of tasks to be completed by the SCO. The method further includes accessing, by a user, the platform using a user device that is separate from the server and in electrical communication with the server. The method further includes receiving, from the user device, input corresponding to an action to be performed by the platform, the action being related to at least one of the student information or the SCO information, and the input including any input information required for the platform to perform the action. The method further includes identifying, by the platform, a priority of each task from the list of tasks based on information associated with each task. The method further includes ordering, by the platform, the list of tasks based on at least one of the identified priority or a due date of each task. The method further includes performing, by the platform, the action related to the responsibilities of the SCO. The method further includes updating, in the database, at least one of the student information or the SCO information in the stored data based on results of the action. The method further includes outputting, on the user device, output data related to completion of the action.

In any of the foregoing embodiments, the action includes at least one action from a plurality of actions and the platform is configured to perform each of the plurality of actions, the plurality of actions including: adding or removing at least one student from the list of students assigned to the SCO; changing the student information related to at least one student from the list of students assigned to the SCO; adding or revising a document or note associated with at least one student from the list of students assigned to the SCO; adding or revising a document or note associated with the SCO; creating an audit report to include at least a portion of the student information from the database associated with each student in the list of students; or adding or marking as complete a task to be completed by the SCO from the list of tasks associated with the SCO.

Any of the foregoing embodiments may further include receiving, from the user device, an identifier of information to be included in the audit report and format information corresponding to a desired format of the audit report, wherein the action includes creating the audit report to include the identified information and to have the desired format.

Any of the foregoing embodiments may further include: detecting, by the platform, a trigger event corresponding to a specific event; and automatically generating and sending, by the platform, an email having a predetermined format and content identified by the SCO in response to detection of the trigger event.

Any of the foregoing embodiments may further include automatically generating and sending, by the platform, an email having information corresponding to an open task and a due date of the open task when the due date of the open task is at least one of the present day or a previous day, wherein the list of tasks includes a due date and a status for each task.

Also disclosed is a system for managing responsibilities of a school certifying official (SCO). The system includes a memory configured to store information usable to host a platform for managing responsibilities of the SCO and to configured to store plurality of students assigned to the SCO and SCO information related to the responsibilities of the SCO, the student information including a list of students assigned to the SCO that correspond to the plurality of students assigned to the SCO and student information associated with each student in the list of students, and the SCO information including a list of tasks to be completed by the SCO. The system further includes a user device configured to be used to access the platform, to receive user input, and to display output data. The system further includes a server in electrical communication with the user device and the memory. The server is configured to host the platform using the information stored in the memory. The server is further configured to receive input from the user device, the input corresponding to an action to be performed by the platform, the action being related to at least one of the student information or the SCO information, and the input including any input information required for the platform to perform the action. The server is further configured to perform the action related to the responsibilities of the SCO. The server is further configured to update at least one of the student information or the SCO information in the stored data based on results of the action. The server is further configured to generate a log entry in response to performance of the action, and storing the log entry in a list of logs in the database. The server is further configured to generate the output data for display on the user device based on completion of the action.

In any of the foregoing embodiments, the action includes at least one action from a plurality of actions and the server is configured to perform each of the plurality of actions, the plurality of actions including: adding or removing at least one student from the list of students assigned to the SCO; changing the student information related to at least one student from the list of students assigned to the SCO; adding or revising a document or note associated with at least one student from the list of students assigned to the SCO, adding or revising a document or note associated with the SCO; creating an audit report to include at least a portion of the student information from the memory associated with each student in the list of students; or adding or marking as complete a task to be completed by the SCO from the list of tasks associated with the SCO.

In any of the foregoing embodiments, the server is further configured to: identify a priority of each task from the list of tasks based on information associated with each task; and order the list of tasks based on at least one of the identified priority or a due date for each task. In any of the foregoing embodiments, the server is further configured to: detect a trigger event corresponding to a specific event; and automatically generate and send an email having a predetermined format and content identified by the SCO in response to detection of the trigger event.

The foregoing features and elements are to be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1A is a block diagram showing an exemplary school certifying official (SCO) system which operates an SCO platform, in accordance with various embodiments of the present disclosure;

FIG. 1B is a block diagram illustrating various components of an exemplary SCO device, in accordance with various embodiments of the present disclosure;

FIGS. 2A-2T illustrate various views of a user interface of a platform similar to the platform of FIG. 1A showing various features of the platform relating to students, in accordance with various embodiments of the present disclosure;

FIGS. 3A-3J illustrate various views of the user interface of FIGS. 2A-2T showing various features of the platform relating to one or more SCO, in accordance with various embodiments of the present disclosure;

FIGS. 4A-4G illustrate various views of the user interface of FIGS. 2A-2T showing various features of the platform relating to an administrative area of the platform, in accordance with various embodiments of the present disclosure;

FIGS. 5A-5F illustrate various views of the user interface of FIGS. 2A-2T showing various features of the platform relating to additional features of the platform, in accordance with various embodiments of the present disclosure;

FIG. 6A illustrates an exemplary log in page of the user interface of the platform of FIGS. 2A-2T, in accordance with various embodiments of the present disclosure;

FIG. 6B illustrates an exemplary management page of the user interface of the platform of FIGS. 2A-2T, in accordance with various embodiments of the present disclosure; and

FIGS. 7A and 7B show a flowchart illustrating a method for managing responsibilities of a SCO, in accordance with various embodiments of the present disclosure.

The subject matter of the present disclosure is particularly pointed out and distinctly claimed in the concluding portion of the specification. A more complete understanding of the present disclosure, however, is best be obtained by referring to the detailed description and claims when considered in connection with the drawing figures, wherein like numerals may denote like elements.

The detailed description of exemplary embodiments herein makes reference to the accompanying drawings, which show exemplary embodiments by way of illustration and their best mode. While these exemplary embodiments are described in sufficient detail to enable those skilled in the art to practice the features of the present disclosure, it should be understood that other embodiments may be realized and that logical, chemical and mechanical changes may be made without departing from the spirit and scope of the disclosure. Thus, the detailed description herein is presented for purposes of illustration only and not of limitation. For example, the steps or blocks recited in any of the method or process descriptions may be executed in any order and are not necessarily limited to the order presented, some steps or blocks that are shown may not be performed, and other steps or blocks that are not shown may be added. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

The present disclosure presents systems and methods for managing efforts by school certifying officials (SCOs). The systems and methods provide several benefits and advantages such as providing tools for training new SCOs and helping new and more senior SCOs perform their job duties. The systems provide additional benefits such as helping experienced SCOs complete their tasks with ease. Additional benefits of the systems described herein include uniform formatting for audit results provided to supervisors or superiors. The systems also advantageously ease the audit process that must be performed by SCOs and facilitate improved compliance with rules and regulations, thus reducing the likelihood that the associated university or college loses the ability to be reimbursed by the Federal Government for veteran students. The systems also provide the benefit of increased security of records stored by SCOs, thus reducing the likelihood of data breaches and associated liabilities.

An exemplary system may operate as a user-based terminal and may be configurable by a user SCO for a given university or college (i.e., a school). Although the system may be configurable by a user, certain operations may be performed by the system regardless of the specific user. Stated differently, the system may be designed to perform various functions for all users (e.g., SCOs) that align with various tasks assigned generally to SCOs, but each individual user may have the ability to reconfigure or redesign some of the functions (or even create new functions) based on specific tasks or responsibilities assigned to the individual user.

The system may be designed to provide various levels of security in order to protect potentially sensitive information from theft or manipulation. For example, the terminal for each school may have a limited quantity of users, such as only one or a few SCOs. This reduces the likelihood of login credentials becoming compromised. The system may also be hosted on private servers rather than a cloud server, making unauthorized access more difficult than if hosted on a cloud server. The system may also incorporate multi-factor authentication to add extra protection in the case of compromised login credentials.

The system allows individual SCOs to have their individual profile within the system and may also organize information in a logical manner for each SCO. For each SCO, the system may store separate records for various types of information. For example, the system may store school documents related to VA compliance by the school in one location, and documents related to all school publications and information used in compliance surveys in another location. The system may also score school catalogs (e.g., including course offerings and requirements for majors) in another location, tuition and fee schedules in a separate location, and annual publication of school policies regarding VA monitored activity in another location. The system may store documents in additional locations, for example, related to financial aid and annual training. The system may be designed to organize the documents in each location in chronological order (or in any other order which may make sense) and may have the ability to combine documents from multiple locations into a single collated and organized set of documents (e.g., organized by chronological order, or by document type or category).

The system may also be configured to at least one of create or store documents in separate locations for each student. That is, each student assigned to an SCO may be assigned their own location or file within the system. The file may record activity logs related to the student that include any information provided, or added, by the SCO regarding the student. For example, the SCO may take an action in the system related to a student, and the system may automatically create a log entry regarding that action. The SCO may have the ability to add new log entries, edit existing log entries, and delete log entries. The SCO may also be capable of annotating any account or other information related to the student in the file assigned to the student. The file may also store information related to scholarships and financial aid that is received by the specific student, as well as information related to a class year of the student and one or more degree for which the student is studying. The file may further include a list of courses already taken by the student and grades achieved therein, along with current courses in which the student is enrolled. The file may include documents related to legal acknowledgements signed by the student that are commensurate with enrollment agreement standards (e.g., the student must keep a GPA above 3.25 in order to maintain a specific scholarship). The system may also provide an opportunity for the SCO to annotate existing records within the student file, as well as add any additional notes to the student file. A separate location may exist for storing documents related to a specific student to reduce the likelihood of documents for one student being provided to another student. The information in the specific student location may be organized in any of a number of manners, such as chronologically.

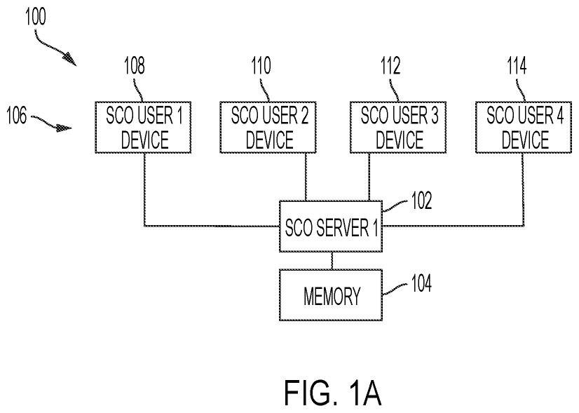

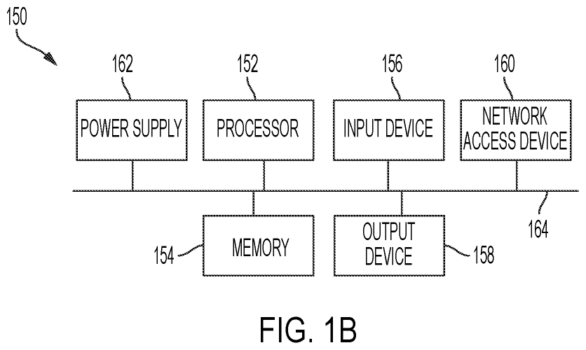

Turning to FIG. 1A, an exemplary system 100 for use by SCOs is shown. The system 100 may include an SCO server 102, a memory 104, and one or more user device 106 including a first user device 108, a second user device 110, a third user device 112, and a fourth user device 114. In that regard, some or all components of the system 100 may function as a distributed system with some components performing some functions of the system 100 and other components performing other functions of the system 100. In some embodiments, some components may perform identical or similar functions (e.g., some of the user devices 106 may perform similar functions). In some embodiments, some functions may be performed by multiple types of components (e.g., certain logical functions may be performed by the SCO server 102 and one or more of the user devices 106; as another example, the SCO server 102 may store certain information in a local non-transitory memory, and the memory 104 may store copies of at least some of the information stored in the local memory of the SCO server 102).

In some embodiments, at least one of the SCO server 102, the memory 104, or the user devices 106 may be or may include a dedicated device designed to operate the platform (e.g., a computer terminal with dedicated hardware and software designed to perform the functions described herein), may be or may include general-purpose devices that are designed or controlled to perform specific functions related to the platform (e.g., by adding software or changing firmware of the respective device), may be or may include general-purpose devices that have not been specifically designed or controlled to function with the platform (e.g., a user device 106 may be used by a user to access a web-based platform hosted on the server 102), or the like.

The SCO server 102 may include one or more server assigned to function with the system to host the SCO platform. The server 102 may be centrally located relative to the specific instance of the SCO platform (e.g., may be located on a campus for a school to which the platform is assigned), may be remote from the other components of the system 100 (e.g., may be a cloud server), or any combination thereof (e.g., one local server may communicate with a cloud server to together host the platform). In some embodiments, the server 102 may include multiple servers spaced apart and logically coupled together.

The SCO server 102 may be capable of communicating with the user devices 106 and the memory 104 via a network (e.g., the Internet, a local area network (LAN), a virtual private network (VPN), or the like). These communications can occur using any known wired or wireless protocol such as Ethernet, Arcnet, Wi-Fi, Bluetooth, or the like. In that regard, each of the components of the system 100 may include a network access device which may be coupled to a processor of the component and may include logic for communicating via one or more communication protocol.

The SCO server 102 may be capable of these communications using one or more security features such as encrypted communications, two-factor authentication, connection via virtual private networks (VPNs), or the like. The server 102 may host information or systems usable by the user device 106 such as functions related to tasks assigned to SCOs. In some embodiments, the server 102 may host the platform and the user devices 106 may access the platform via connection with the server 102 such that some or all operations related to SCO tasks are performed by the server 102, and the user devices 106 provide access to the operations via the server 102. In some embodiments, the user devices 106 may each perform operations related to the SCO tasks such that some or all of these operations are performed by the user devices 106. In some embodiments, the server 102 and user devices 106 may each perform some or all operations related to the SCO tasks. In some embodiments, tasks may be duplicated by the server 102 and the user devices 106; in such embodiments, the availability of processing power and memory may dictate which component processes which tasks.

The user devices 106 may include any user devices capable of performing logical functions such as a personal computer (PC), a laptop, a tablet, a smartphone, or the like. A user may access the platform via the user devices 106. The user may include, for example, a SCO, a school employee, a supervisor of the SCO, a representative from the Federal Government, or the like. Each user may be assigned a specific username and password and may access the platform using the username and password. The communications between the server 102 and the specific user device 106 assigned to the user may be encrypted. Furthermore, two-factor authentication may be required in order to allow the user to access the platform. In some embodiments, the user devices 106 may run client software for the platform such that a user interfaces with the platform via the client software. In some embodiments, the user devices 106 may only provide access to the server 102 such that a user interfaces with the platform via the connection to the server 102 (e.g., the user may access the platform via a web interface hosted by the server 102).

The memory 104 may include any non-transitory memory such as random-access memory (RAM), dynamic random-access memory (DRAM) read-only memory (ROM), or any other type of memory. The memory 104 may be housed within the server 102, may include remote memory (e.g., cloud-based memory) that is accessed by at least one of the server 102 or a user device 106 (e.g., the memory 104 may include a database), may be external relative to the server 102 (e.g., an external hard drive or database), or any combination thereof. In that regard, the memory 104 may be positioned in a same general location as the server 102, may be positioned in a separate location from the server 102, or may include multiple memories such that one or more memory is in a similar location as the server 102 and another one or more memory is positioned separately from the server 102. The memory 104 may store information usable by at least one of the server 102 or the user device 106 to perform logic functions, may store information as requested by at least one of the server 102 or the user device 106 for later retrieval, or the like. For example, the platform disclosed herein may store certain documents or other records, and these documents or other records may at least partially be stored in the memory 104. In some embodiments, at least a portion of these documents or records may be stored on a memory of the server 102, may be stored on a user device 106, or any combination thereof.

As mentioned above, various security measures may be utilized within the system. For example and as referenced above, two-factor authentication (or multi-factor authentication using more than two factors) may be required in order to log into the platform. Furthermore, the platform may only be accessed using a virtual private network (VPN) to which only authorized users are provided access. In addition, encryption may take place in all communications between a user device 106 and the server 102, reducing the likelihood of a bad actor being able to access any intercepted communications. Encryption may also be applied to all data that is stored in the memory 104 (whether the memory 104 is a local memory connected to the server 102, an external memory connected to the server 102, cloud memory, or any other type of memory), further reducing the likelihood that any hacked information will be accessible to the bad actor.

In some embodiments, each school may utilize a separate instance (or may have a separate environment) of the platform, reducing the likelihood that a lapse in security at one school will affect other schools. In that regard, each school may have a separate system 100 with a server 102, a memory 104, and user devices 106 networked together. Separating each school further reduces the likelihood that a mistake by a user at one school will affect the stored data or functions at another school. In some embodiments, a single system 100 may be utilized for multiple schools. In that regard, one or more user devices 106 may be associated with each school, and may access a central server 102 that is shared by multiple schools. In these embodiments, each school may have it's own dedicated memory, a memory may be shared between schools, or any combination thereof.

Referring to FIGS. 1A and 1B, an exemplary SCO device 150 is shown. Any one or more of the SCO server 102, the memory 104, or one or more user device 106 may include some or all of the features of the exemplary SCO device 150. The SCO device 150 may include greater or fewer components than shown in FIG. 1B, may include duplicates of some components (e.g., the SCO device 150 may be a dual processor device), or the like.

The SCO device 150 may include a controller or processor 152. The processor 152 may include any controller or processor capable of performing logic functions. For example, the processor 152 may include an application-specific integrated circuit (ASIC), a general-purpose processor, a field programmable gate array (FPGA), any combination of discrete logic devices that perform logic functions, or the like. In some embodiments, the processor 152 may further include a local memory that stores instructions usable by the processor 152 to perform logic functions (e.g., cache memory, RAM, or the like). The processor 152 may be housed within the SCO device 150, may include remote functionality (e.g., by providing cloud-based processing), or any combination thereon.

The SCO device 150 may further include a memory 154. The memory 154 may include any non-transitory memory such as random-access memory (RAM), dynamic random-access memory (DRAM) read-only memory (ROM), or any other type of memory. The memory 154 may be housed within the SCO device 150, may include remote memory (e.g., cloud-based memory or an external database), may be external relative to the SCO device 150 (e.g., an external hard drive), or any combination thereof. The memory may store information usable by the processor 152 to perform logic functions, may store information as requested by the processor 152 for later retrieval, or the like.

The SCO device 150 may further include an input device 156. The input device 156 may include any one or more input device such as a mouse, a keyboard, a touchscreen, a microphone, or the like. The input device 156 may receive input from a human user and convert the input into digital signals usable by the processor 152.

The SCO device 150 may further include an output device 158. The output device 158 may include any one or more output device such as a display, a touchscreen, a printer, a speaker, or the like. The output device 158 may receive a digital signal from the processor 152 and may convert the digital signal into a format that can be interpreted by a user (e.g., text or images on a screen, audio data, or the like).

The SCO device 150 may also include a network access device 160. The network access device 160 may include one or more device capable of communicating with external elements via any wired or wireless protocol. For example, the network access device 160 may be or include a network card or adapter and port that facilitates communications via Ethernet, Bluetooth®, Wi-Fi, universal serial bus (USB), cellular protocols (e.g., 5G), or the like. In that regard, the network access device 160 may communicate with the processor 152, may transmit information from the processor 152 to a remote device as requested by the processor 152, and may transmit information from a remote device to the processor 152. The network access device 160 may communicate with remote devices (e.g., may communicate with a remote server via the internet), may communicate with local devices (e.g., may communicate with a local printer), or the like. In that regard, the SCO server 102, the memory 104, and the SCO user devices 106 may communicate with each other via respective network access devices 160 and external communication means (e.g., ethernet cables, Wi-Fi routers, 5G routers, or the like).

The SCO device 150 may further include a power supply 162. The power supply is designed to provide power to the SCO device 150, providing electricity to the components of the SCO device 150 to allow them to operate. The power supply 162 may include any power supply and related components such as a cable and transformer designed to receive power from a wall socket, a converter or inverter, a battery, a supercapacitor, or any alternative or additional power supply.

The SCO device 150 may also include connections or a bus 164. The connections or bus 164 may be connected to some or all components of the SCO device 150 and may transmit at least one of a power signal or a data signal between components of the SCO device. For example, power from the power supply 162 may be transmitted to the various components via the connections or bus 164, the processor 152 may control the output device 158 by placing instructions on the connections or bus 164, the processor 152 may receive information from the network access device 160 via the bus 164, or the like. In some embodiments, the power provided by the power supply 162 may be distributed via the bus 164, may be distributed via a separate bus or connection, or the like.

At least one of the SCO server 102 or a user device 106 may host or provide access to a platform that is accessible by various SCOs and other potential users. The platform may retain or store information related to various entities including users, schools, students, SCOs, and logs. A user of the system may be able to at least one of view or edit some or all information relating to the entities. The entity information may be specific for each instance of the platform (i.e., a first SCO at a first school may interface with a first instance of the platform, and a second SCO at a second school may interface with a second instance of the platform; along these lines, a third SCO at the first school may interface with the first instance or may have a separate instance).

The information relating to the various entities may vary based on the specific type of entity. For example, the platform may store a specific role for each user. The platform may store different information for a specific school, which may include: available benefits, available scholarships, document types which may be stored, semesters, available degrees, available degree programs, available courses, fees, fee amounts, contacts, queued emails, and email templates. The platform may additionally store different information for students, which may include: tasks related to each student, personal information for each student (e.g., name and date of birth), contact information for each student (e.g., email and phone), school information for each student (e.g., school identification, campus, and degree), address information for each student, a branch of military service in which each student served, year(s) in which the student served, a rank the student achieved while serving, discharge information for the student (e.g., date of discharge, type of discharge (e.g., honorable discharge, dishonorable discharge), or the like) semester information (e.g., benefits, blocks (if semesters are divided into blocks), scholarships, notes for each student for a specific semester, and fee information for each student), documents related to each student (e.g., diplomas, certificates, or the like), general notes for the student, and an activity log relating to any changes in the data stored that relates to the student. The platform may store information for each SCO, which may include: tasks assigned to each SCO, documents stored in the platform that are associated with each SCO, and notes associated with each SCO. The platform may further store logs relating to the platform; these logs may include activity logs, audit logs, and error logs.

The platform may be designed to facilitate audits performed by SCOs. This is advantageous because, in conventional systems, SCOs must prepare for audits by manually retrieving various documents and records (which is time consuming), determine a format in which to provide information, and prepare documents with the information using the determined format. Conventionally, each SCO prepares the documents in different formats, thus making it difficult and time consuming for a reviewer to review and understand the information associated with the audit.

The platform may also be capable of generating or updating various forms. In particular, the platform may be designed to generically generate a form based on a desired form type and property mapping. For example, the platform may be provided with templates for multiple types of forms, and may select a template based on the type of form that is requested (e.g., a new student formation form used to add a new student to the roster of an SCO). The platform may receive, e.g., from an SCO, at least one of information to be added to a field in a form (e.g., a class year of the student or branch of military in which the student served) or a selection from a drop-down menu (e.g., a major of the student or a list of scholarships awarded to the student). In some embodiments, the platform may populate a drop-down menu before a selection by the user such that the generated form provides the option for the user to select the information from the drop-down menu. In response to receiving this information, the platform may generate an at least partially populated form of the specified type which includes the information for use in the field.

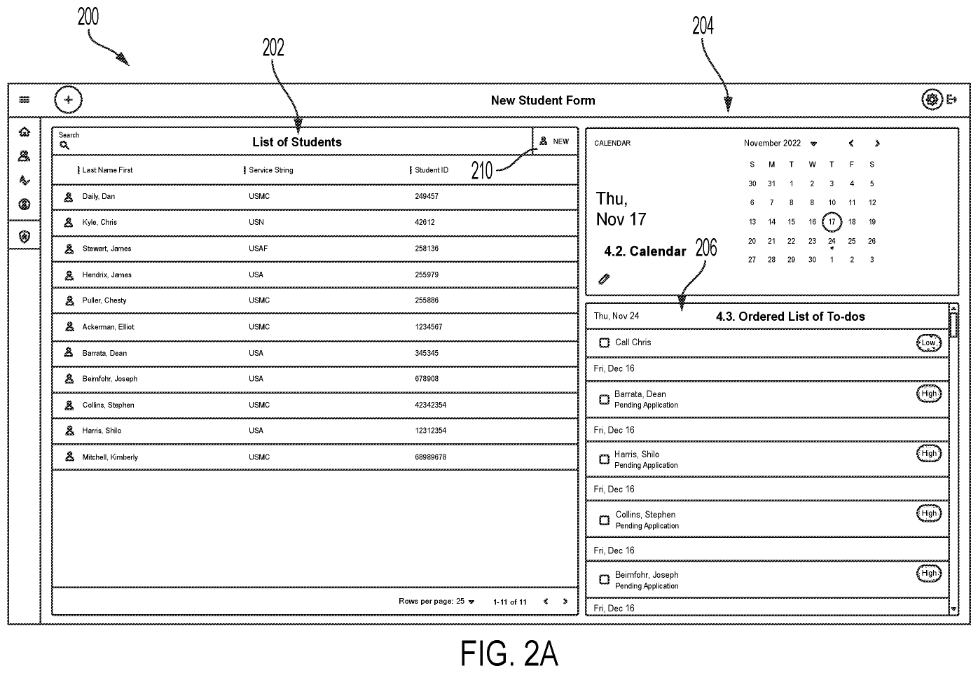

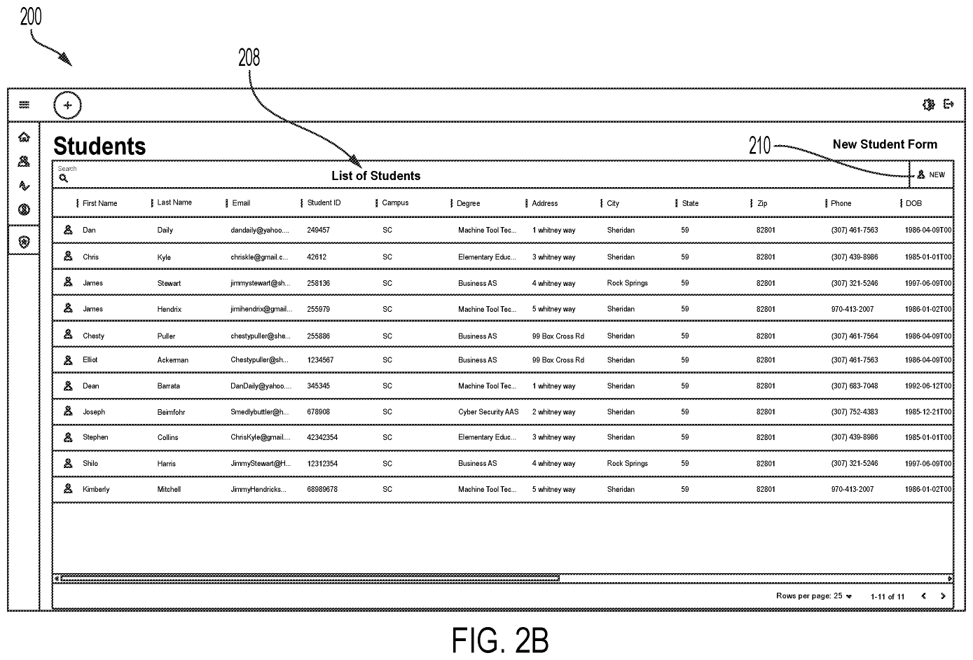

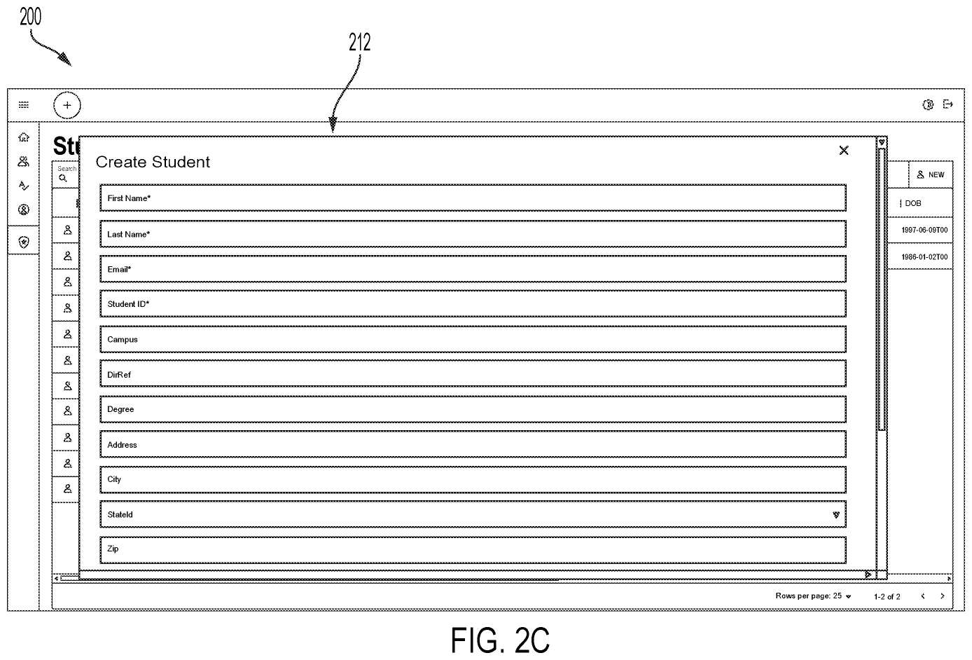

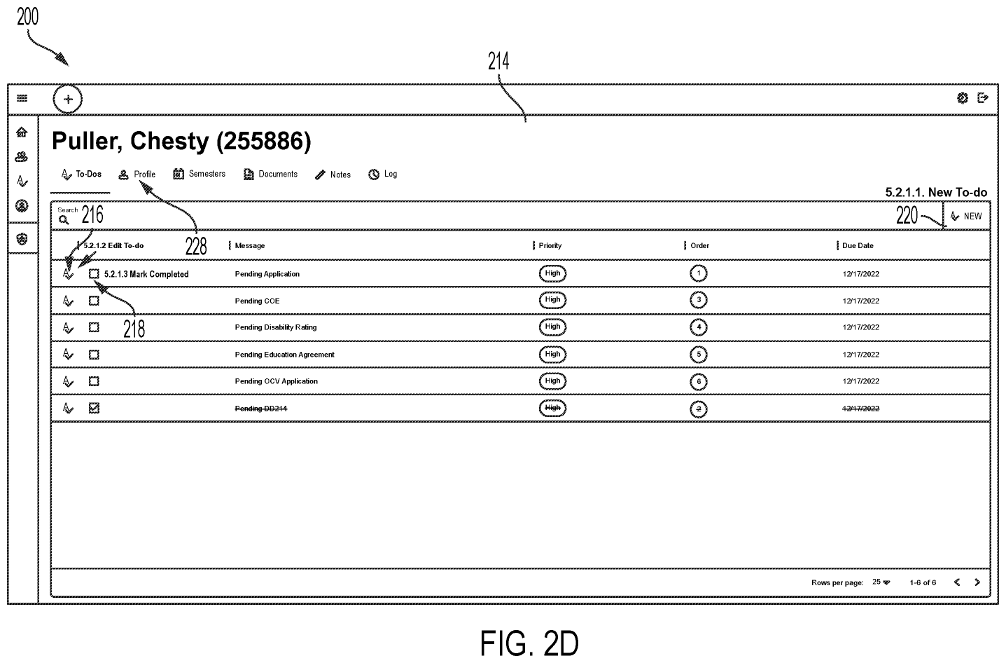

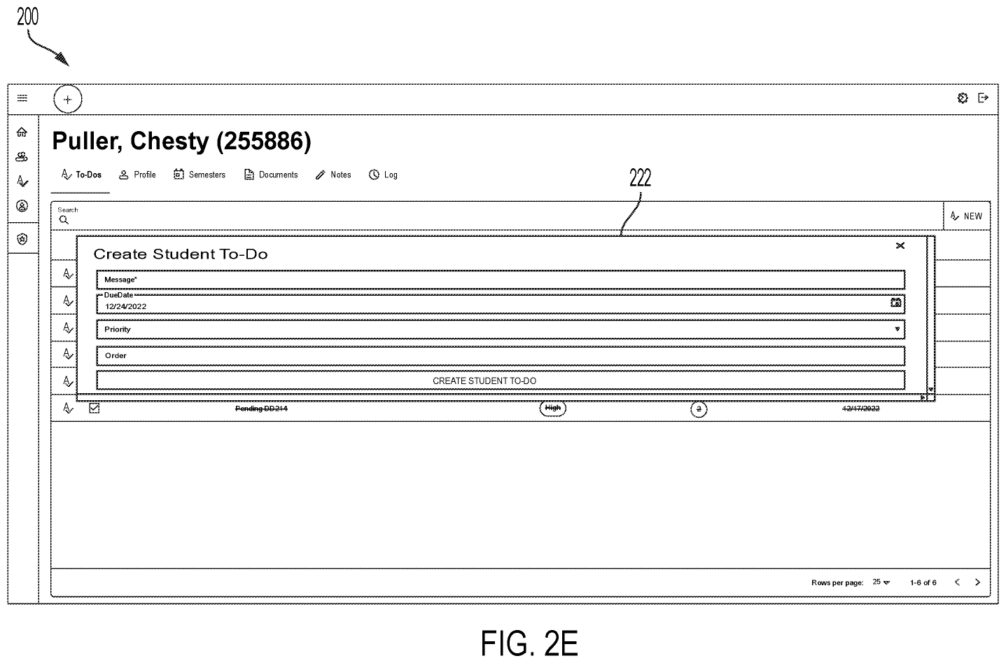

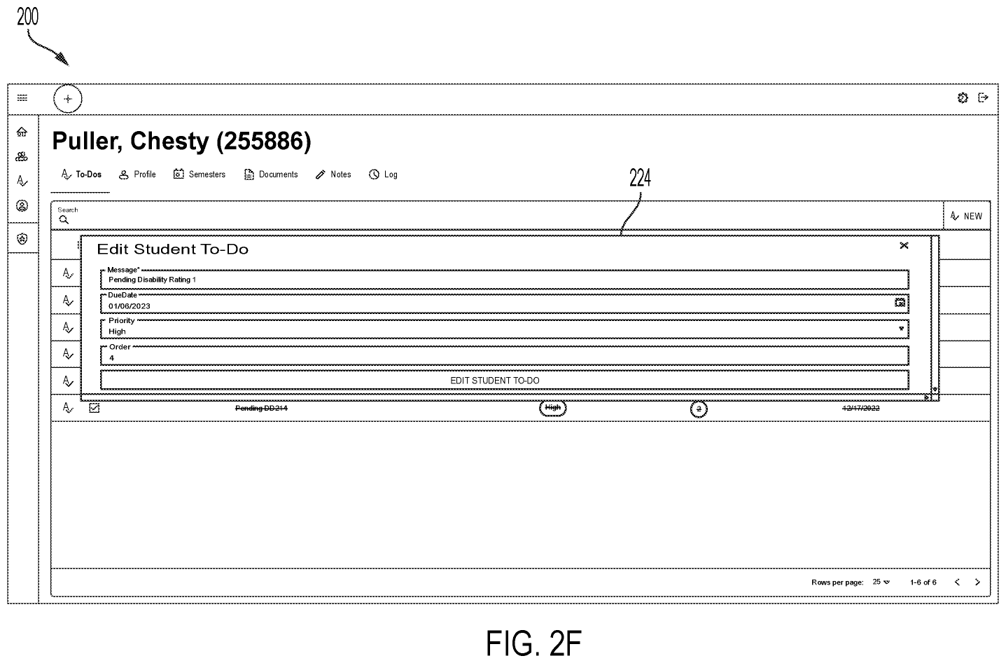

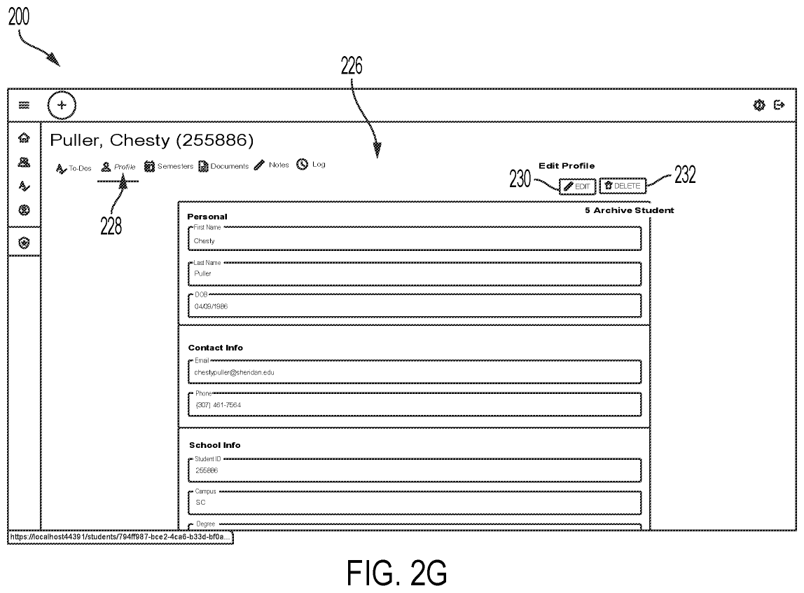

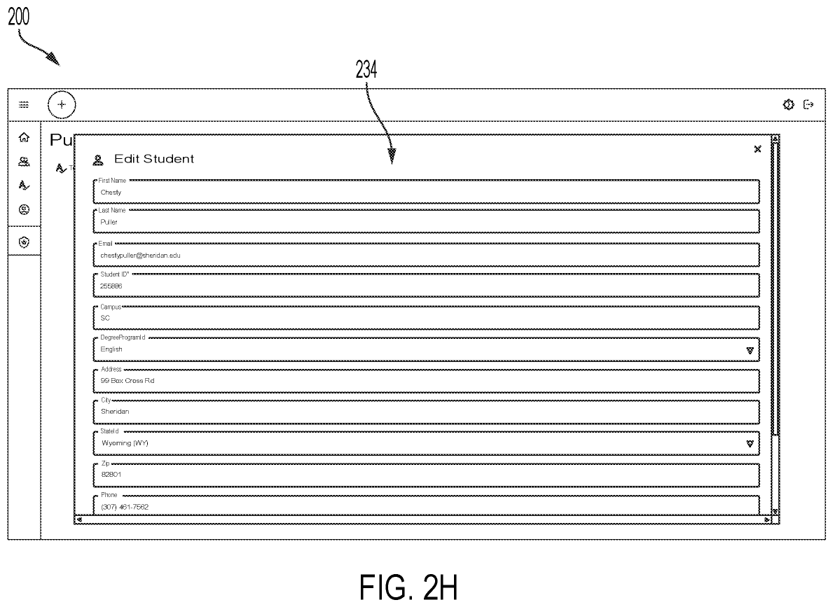

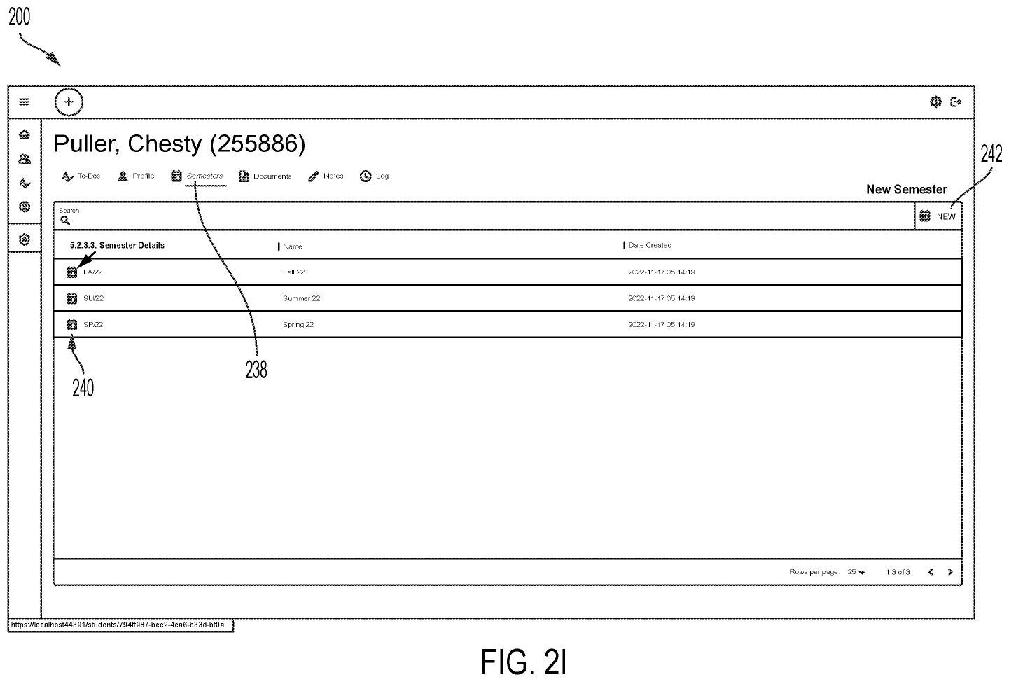

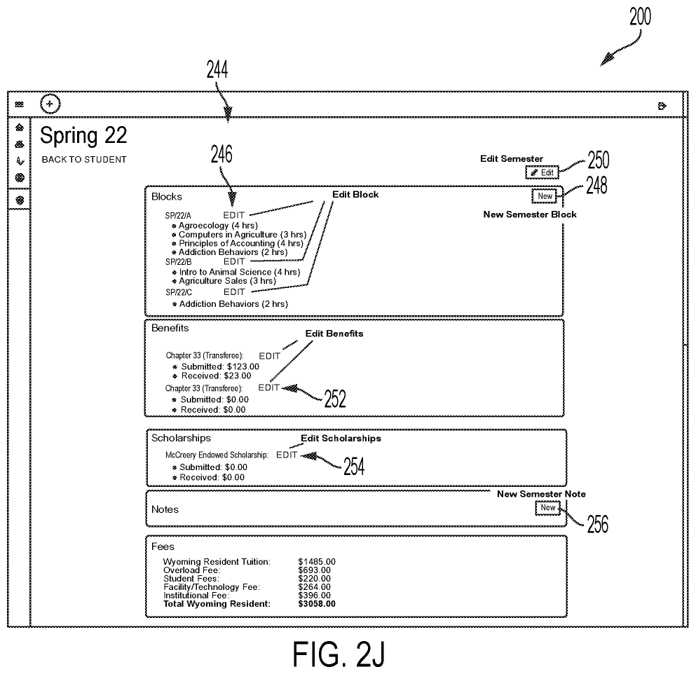

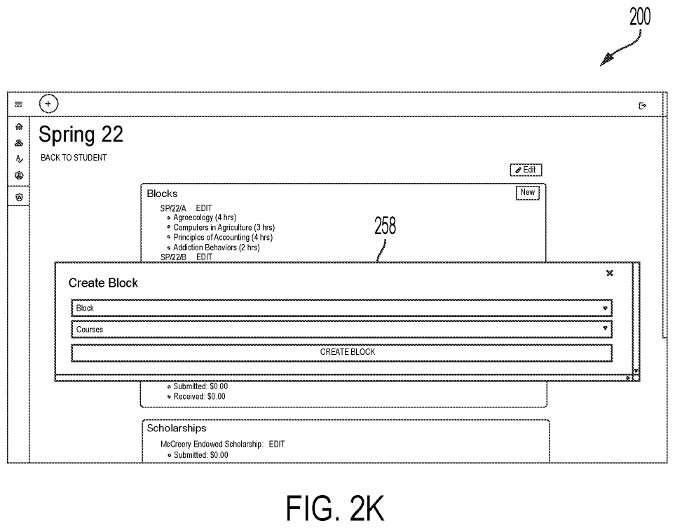

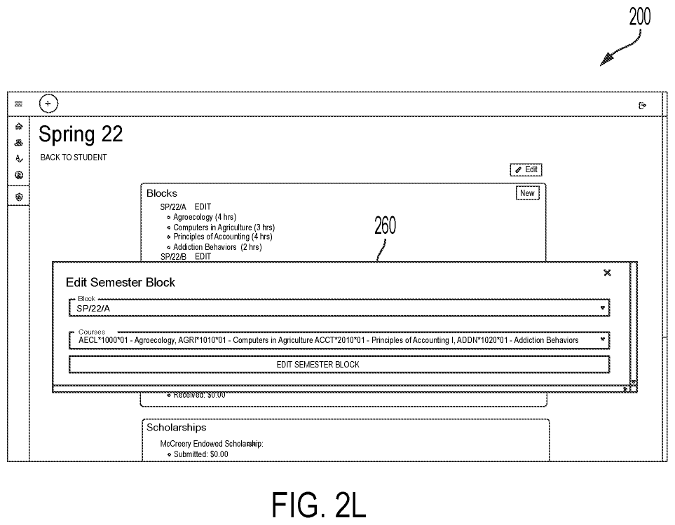

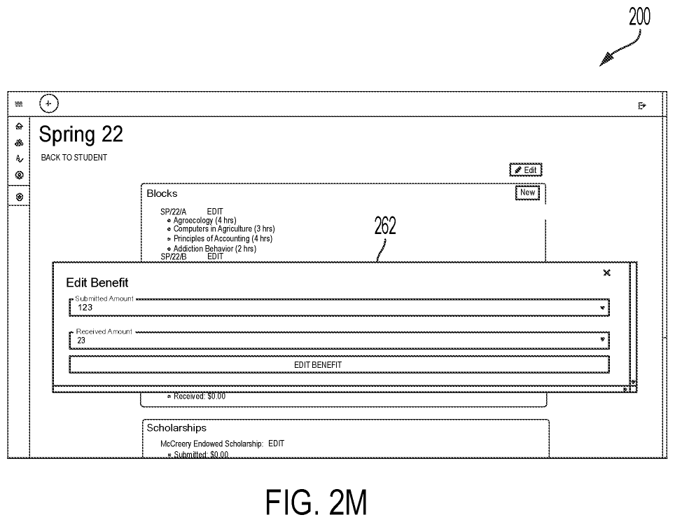

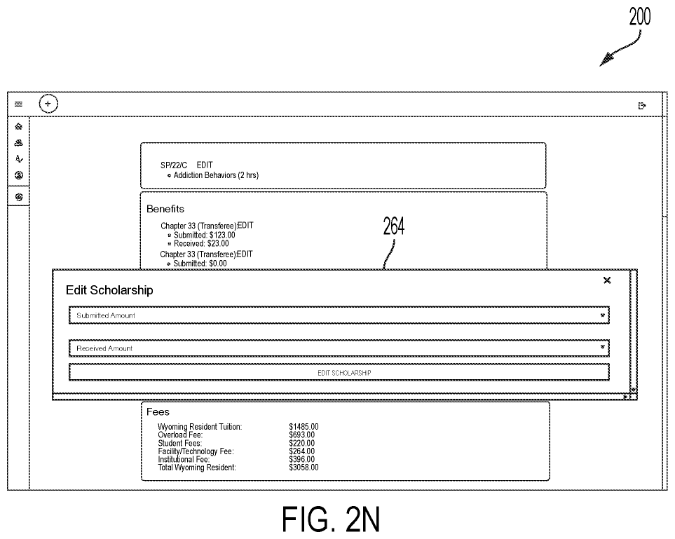

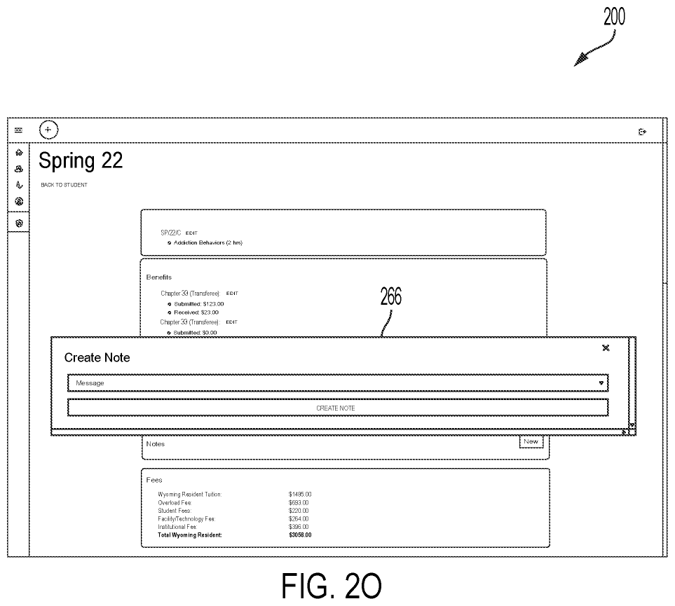

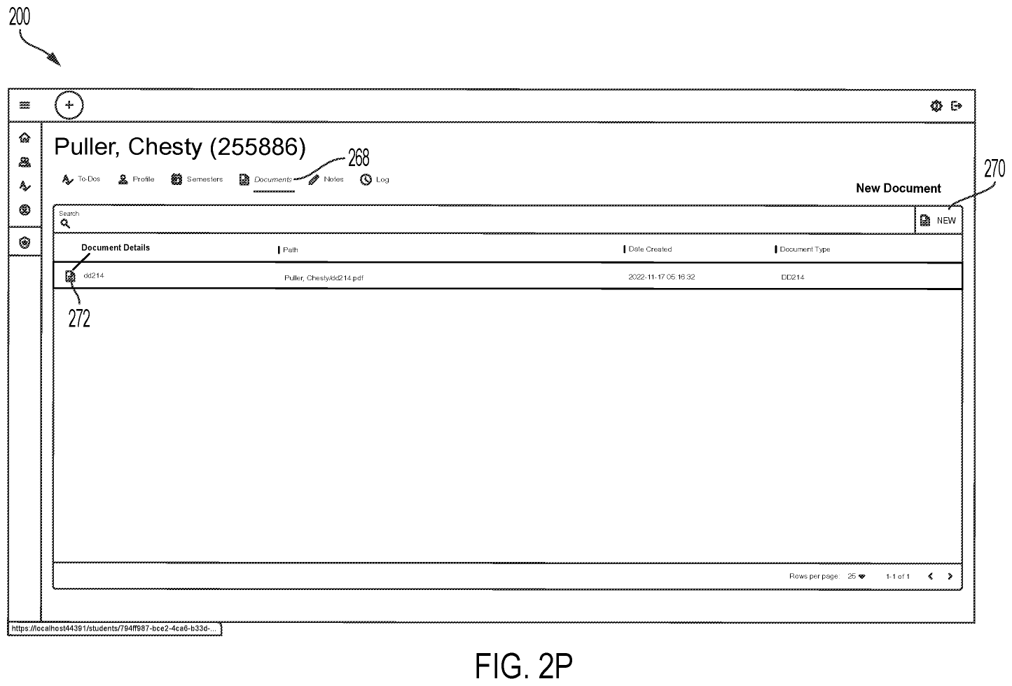

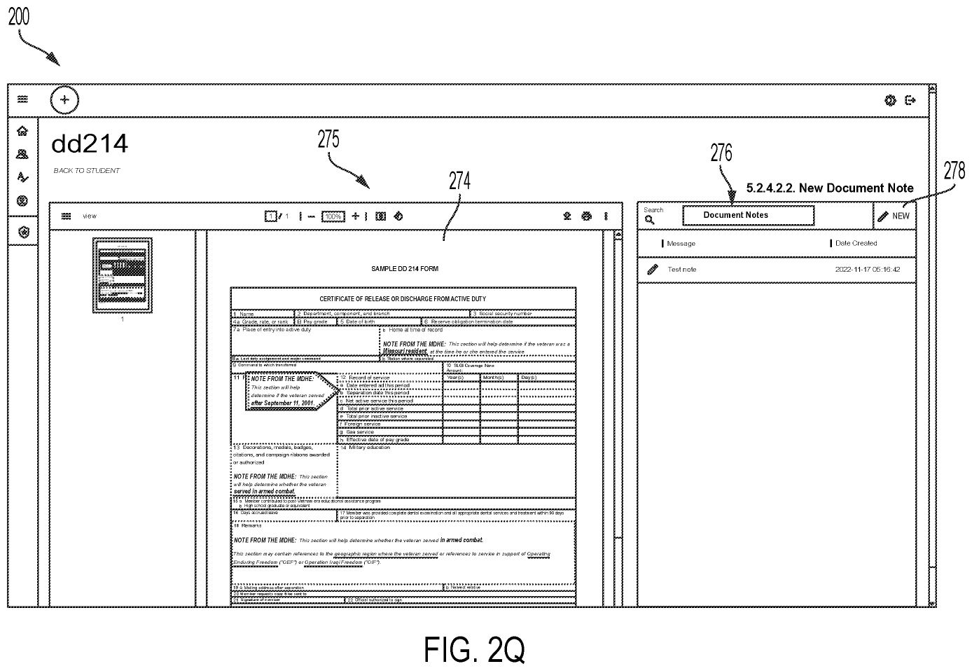

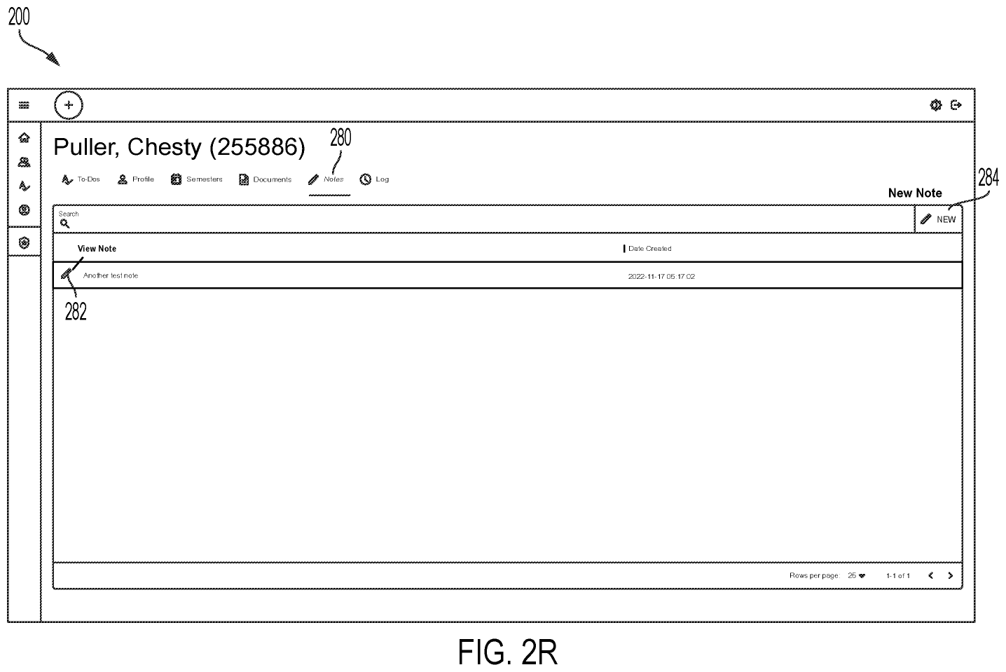

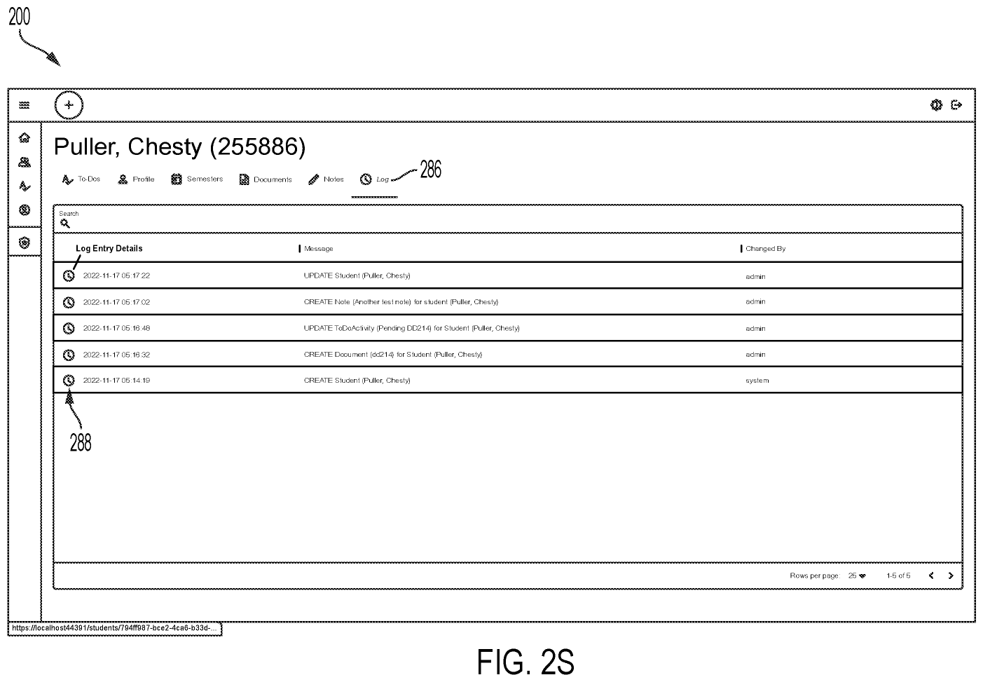

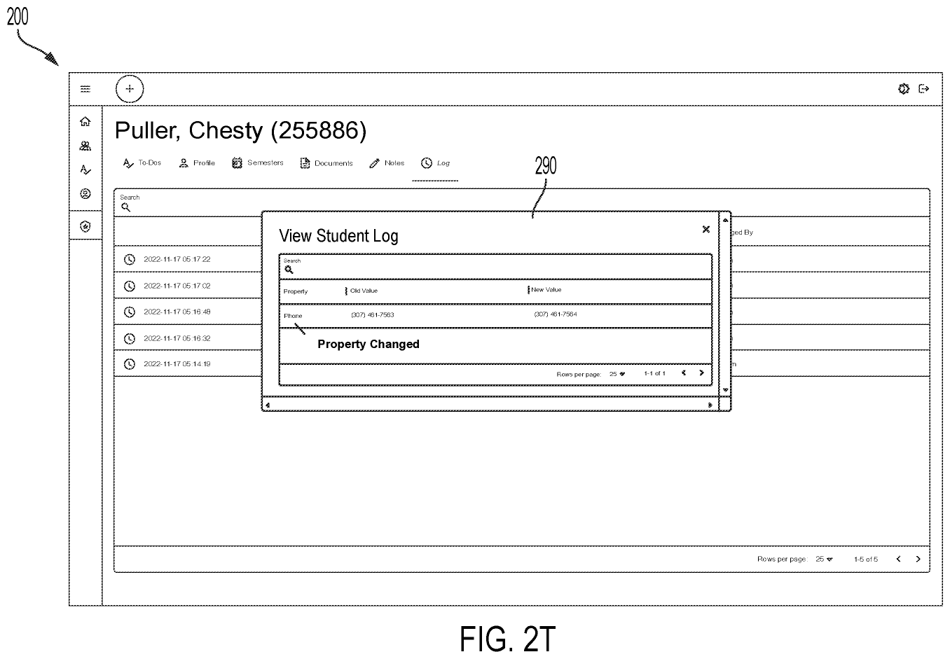

Referring to FIGS. 2A through 2T, various views of the platform, or screenshots, related to students assigned to an SCO are shown as viewed by the SCO. For example, these drawings may illustrate various views of a user interface (UI) 200 (e.g., a graphical user interface (GUI)). Although some features may be illustrated and discussed in connection with a specific location in the UI 200, one skilled in the art will realize that some or all features of the platform may be accessed at more than one location in the UI 200. The information illustrated by the UI 200 may be stored on an SCO server (e.g., the SCO server 102 of FIG. 1A), a separate memory or database (e.g., the memory 104 of FIG. 1A which may include, for example, a local database or a cloud memory), on a user device (e.g., the user device 108 of FIG. 1A), or any combination thereof.

FIG. 2A shows a summary page for students assigned to an SCO as viewed using the UI 200. As shown, this page provides a brief list of students 202 that are assigned to the SCO, a calendar 204, and an ordered list of tasks 206 that are assigned to the SCO. The list of students 202 may show some information related to the students but may not show all student information in order to provide room for the calendar 204 and the list of tasks 206. For example, the list of students 202 may show the student's name, a branch of service in which the student served, and an identifier of the student (e.g., a username, a student identifier number assigned by the school or by the military, a social security number, or the like). In some embodiments, the SCO may use the UI 200 to personalize the information that is shown in the list of students 202 to add some information and remove other information. For example, the SCO may personalize the list of students 202 to show a degree program in which the student is enrolled in place of the student ID.

The calendar 204 may show dates within a selected month. In some embodiments, the calendar 204 may correspond to a current month; for example, if the date is Dec. 2, 2022 then the calendar may show the dates in December of 2022. In some embodiments, the user may change the selected month in the calendar 204, may select any date within the month, or the like. In response to selection of a date by the user, the UI 200 may switch to a calendar view as described elsewhere herein.

The list of tasks 206 may be ordered. For example, the SCO may personalize the list of tasks 206 using the UI 200 to cause the tasks to be ordered based on different information. As shown in FIG. 2A, the tasks are ordered by due date. However, the SCO may cause the tasks to be ordered based on different criteria such as by student name, by priority of the task, or the like. The tasks may be auto-created based on input provided by the SCO (e.g., the platform may create a task to review an application for each new student added to the platform) or may be manually created by the SCO as described elsewhere herein.

The platform (e.g., as running on the server 102 of FIG. 1A) may determine a priority of each task based on at least one of information provided by the user or based on information associated with the event. For example, the platform may be aware that grades of a specific student are below a predetermined threshold grade level. The platform may determine that each task associated with the student is of increased importance and may set each of these tasks associated with the student as tasks of the highest priority. As another example, the platform may be informed that a student has graduated. The platform may determine that each task associated with this student is of the lowest priority. In some embodiments, the priority of one or more task may be provided by the user. In some embodiments, the platform may identify a priority of each task, and the priority may be changed in response to input by the SCO.

FIG. 2B shows a complete list of students 208 for students assigned to the SCO. For example, the SCO may click on the summary list of students 202 in the UI 200 to cause the UI 200 to show the complete list of students 208. As shown, the complete list of students 208 includes more information for each student than is shown in the summary list of students 202. All of the information displayed in the summary list of students 202 may be stored in the complete list of students 208.

Some views of the UI 200 may include one or more buttons that are selectable by the SCO to perform various operations. Where used herein, a button may include a logical or physical element that may be selected by manipulation or contact with a physical button, may be selected using an input device of an electronic device (e.g., a keyboard of a laptop, a touchscreen of a mobile phone, a stylus of a tablet, etc.), or the like. In that regard, any item which may be selected by a user, whether digital, physical, logical, or the like, may be referred to as a button.

The UI 200 may include a new student button 210 that opens a new student creation form 212, which is shown in FIG. 2C. In response to clicking the new student button 210, the new student creation form 212 may be displayed on the UI 200. The new student creation form 212 may include fields which the SCO may populate in order to add a new student to the list of students assigned to the SCO. The fields may be populated by making a selection from a drop-down menu for each field, by typing in information, or the like. For example, some fields may provide a drop-down menu from which the SCO may make a selection (e.g., a major of studies, a branch of the military, or the like) and some fields may require typing due to the relatively long list of options (e.g., a student name, a student identifier, an address, or the like).

In some embodiments, the platform may auto-populate some or all of the fields in the new student creation form 212. In some embodiments, the platform may communicate with a database of students that is maintained by the school to retrieve some or all of the information related to the student based on the student's name. In some embodiments, the platform may be unable to communicate with any other system maintained by the school in order to maintain security of information stored in the platform. Once the new student is added, the information related to the new student will remain in the list of students (e.g., in the summary list of students 202 of FIG. 2A and the complete list of students 208 shown in FIG. 2B, and may also stored in a database for the SCO such as the memory 104 of FIG. 1A).

The SCO may click on the name or row of a student in at least one of summary list of students 202 of FIG. 2A or the complete list of students 208 shown in FIG. 2B in order to open a student tasks window 214 which is shown in FIG. 2D. The student tasks window 214 may list information related to each task that is assigned to the SCO for the selected student. For example, this information may include a subject of the task, a priority of the task, and a due date for the task. The list of tasks may be automatically ordered by the platform, may be ordered by the SCO, or the SCO may provide instructions to the platform (e.g., using the UI 200 and an input device) regarding how to order (e.g., by priority, by due date, or the like).

The student tasks window 214 may provide edit task buttons 216, complete task buttons 218, and a new task button 220. FIG. 2E shows a new task window 222 of the UI 200 that is displayed in response to the user selecting the new task button 220. As shown, the user may populate the fields related to the new task that is being added. In some embodiments, some or all of the fields may be automatically populated by the platform, may be populated by the SCO, or the like. The fields may be populated by making a selection from a drop-down menu, by typing in information, or any combination thereof. For example, the SCO may enter an identifier of the new task (e.g., a task may include obtaining a specific signed document from the student) and the platform may assign a priority to the task based on the identifier of the task (e.g., using logic that equates certain types of tasks with predetermined priority levels). In some embodiments, the SCO may assign a priority to the task, or may change a priority for a task that was set by the platform.

FIG. 2F shows an edit student task window 224 which may be displayed in response to the user selecting a specific edit task button 216 (shown in FIG. 2D). As shown, the user may edit any of the populated fields for the specific task using the edit student task window 224. In some embodiments, the edit student task window 224 may provide an option for the SCO to select a new option from a drop-down menu, to type in new information into a field, or to replace selected text from a drop-down menu with free-form text entered by the SCO.

Returning reference briefly to FIG. 2D, after the SCO has completed a specific task in the student tasks window 214, the SCO may select a respective complete task button 218. After selecting the respective compete task button 218, the selected task may be shown as completed, and the change may be propagated throughout the platform. For example, the task may be removed from the list of tasks 206 shown in FIG. 2A.

As shown, e.g., in FIG. 2D, the UI 200 may include a student profile button 228. In response to selection of the student profile button 228, the UI may show a student profile window 226, as shown in FIG. 2G. The student profile window may show various information stored in the student profile such as a name, a birth date, contact information, school-related information (e.g. a student identifier, a campus on which the student is located, a degree towards which the student is working, or the like), or the like.

The student profile window 226 may include a profile edit button 230 for editing the student profile and a profile delete button 232 for deleting the student profile. In response to the SCO selecting the profile delete button 232, the student profile may be removed from the active views of the SCO within the UI (e.g., the student may be removed from the summary list of students 202 of FIG. 2A or the complete list of students 208 shown in FIG. 2B). Although the student may be removed from the active views of the UI 200, the student profile data may be archived and stored in a memory so the student records are not permanently deleted. In some embodiments, the platform may permanently delete the student records after a period of time has elapsed (e.g., 1 year, 2 years, 5 years, or the like) since the deletion occurred. In some embodiments, the period of time may be adjusted by the SCO based on specific rules of the school. In some embodiments, the platform may be programmed with the period of time based on the specific rules of the school and may permanently delete the student records after the period of time has elapsed since deletion by the SCO.

In response to a user selecting the profile edit button 230, a profile edit window 234 may be displayed, as shown in FIG. 2H. The profile edit window 234 may include similar fields as those in the new student creation form 212. In that regard, the SCO may edit any one or more of the fields within the profile edit button 230. In some embodiments, some of the fields may be fixed and non-changeable. For example, if the platform retrieves some information regarding the student from an external system (e.g., a military server that provides information about a veteran's service record, or a school server that provides information regarding the student's education) then those fields may remain constant and be non-changeable. In some embodiments, a warning may be displayed in response to an SCO attempting to change information in a fixed field, and the SCO may change the fixed information by acknowledging the warning and indicating a desire to change anyway.

Turning to FIG. 2I, additional semester details of the UI 200 are shown. For example, the view of FIG. 2I may appear in response to a user selecting a semesters button 238. This view of the UI 200 may list at least one of past, present, or future semesters in which the specified student was/will be enrolled at the school. In that regard, the semester details screen may be associated with a previously selected student. In this view, the SCO may view semester details for a selected semester by clicking or otherwise selecting a semester details button 240 for the respective semester. The SCO may also add a new semester for the student by selecting a new semester button 242.

In response to a selection of the semester details button 240, a semester details window 244 may be displayed, as shown in FIG. 2J. The displayed semester details may include various semester blocks for the student (e.g., semesters in which the student took classes or is enrolled) and courses therein, student benefits assigned to the student (e.g., financial benefits that the government committed to paying for the student), scholarships awarded to the student, notes for the student, and fees paid by or due from the student (e.g., to attend an upcoming semester or due for a current semester). In some embodiments, the school may not utilize semester blocks and may be on a semester-only schedule; in these embodiments, the semester details window 244 may only show courses without any individual blocks.

The semester details window 244 may also include a new semester block button 248 and an edit semester button 250. The new semester block button 248 may be used by the SCO to create a new semester block within the semester that is currently being viewed, and the edit semester button 250 may be used to edit information within the semester that is currently being viewed. The edit semester button 250 may allow the SCO to change any information within the semester details window 244 for the selected semester, for example, by entering new information, replacing certain information, or making a new selection from a drop-down menu.

The semester details window 244 may further include one or more edit benefits button 252, one or more edit scholarships button 254, and a new semester note button 256. The edit benefits button 252 may be used to edit current benefits assigned to the student, the edit scholarships button 254 may be used to edit information related to scholarships that have been awarded to the student, and the new semester note button may be used to add a new note to the currently viewed semester for the selected student. The new note may include any information the SCO desires.

Referring to FIGS. 2J and 2K, a create block window 258 may be displayed in response to the SCO selecting the new semester block button 248. The SCO may utilize the create block window 258 to create a new semester block. For example, the SCO may select or input a semester block and courses in which the student is enrolled for that block.

Turning to FIGS. 2J and 2L, an edit semester block window 260 may be displayed in response to the SCO selecting one of the edit block buttons 246. The edit semester block window 260 may include fields for the identifier of the selected block and for courses for that block in which the student is indicated as being enrolled. The SCO may change either of these fields in the edit semester block window 260.

Referring to FIGS. 2J and 2M, an edit benefit window 262 may be displayed in response to the SCO selecting an edit benefit button 252. Veteran students may be awarded benefits for education, and the edit benefit window 262 may assist the SCO in keeping track of such benefits awarded to each student. For example, Chapter 33 benefits may be awarded to the student and may cover at least a portion of tuition and fees, a monthly housing allowance, a stipend for books and supplies, and the like. The edit benefit window 262 may provide fields for an amount of benefit that has been requested for the student, and an amount of the benefit that has been received. For example, the SCO may update the amount of benefit indicated as received for the selected benefit in response to receiving notice that a new portion of the benefit has been received. In some embodiments, the SCO may have the option in the edit benefit window 262 to add a new benefit that has been assigned to the student. In some embodiments, the benefit information for the selected semester may be automatically populated based on communication with an external system such as a server associated with the school or a server associated with the Federal Government.

Referring to FIGS. 2J and 2N, an edit scholarship window 264 may be displayed in response to the SCO selecting an edit scholarship button 254. The edit scholarship window 264 may provide fields for an amount of the scholarship award for which the student has requested or submitted, and an amount of the scholarship award that has been received by the student (or by another entity on behalf of the student). In that regard, the SCO may update the amount of the scholarship award that has been received in response to the student receiving at least a portion of the scholarship, or another entity receiving at least the portion of the scholarship on behalf of the student. In some embodiments, the SCO may have the option in the edit scholarship window 264 to add a new scholarship that has been awarded to the student. In some embodiments, the scholarship information for the selected semester may be automatically populated based on communication with an external system such as a server associated with the school or a server associated with the Federal Government.

Referring to FIGS. 2J and 2O, a new note window 266 may be displayed in response to the SCO selecting the new semester note button 256. The new note window 266 may provide a field in which the SCO can add a new note for the student in the selected semester. The new note can include any information that the SCO wishes to add. For example, if the student has applied for a new scholarship that has not yet been awarded, the SCO may add a new note to check on the status of the new scholarship. As another example, the SCO may add a new note to save information usable by the SCO to strengthen his relationship with the student (e.g., a list of hobbies of the student).

Referring to FIG. 2P, a list of documents related to the selected student are shown. The documents may be documents that are added by the SCO. In some embodiments, one or more document may be retrieved from an external system such as a server associated with the school or a server associated with the Federal Government. For example, the platform may retrieve a service record of the student from a Federal Government server, or a scholarship notification document from a school server. In the view of FIG. 2P, a new document button 270 and one or more document detail buttons 272 are provided. The SCO may select the new document button 270 to upload or otherwise add a document for the student, and may select a document detail button 272 to view details regarding the document. For example, if the SCO obtains a document associated with the student (e.g., a transcript from a school which the student previously attended) then the SCO may select the new document button 270, and the platform may provide an option for the SCO to upload the document. For example, the SCO may upload the document using a scanner, by taking a picture and uploading it, by copying it from elsewhere on the user device, or the like.

Turning to FIGS. 2P and 2Q, a document details window 275 may be displayed in response to the user selecting a document detail button 272. The document details window 275 may display a copy of the selected document 274 along with a list of document notes 276. The document notes 276 may include any notes that the SCO has added regarding the selected document. For example, the document notes 276 may include a description of the document, a source of the document, or any other information regarding the document which the SCO added. In that regard, the document details window 275 may also include a new document note button 278 that allows the SCO to add a new note to be associated with the document. In response to selection of the new document note button 278, the platform may provide a window in which the SCO can add the new note. After the new note is added, it will show up in the document notes 276.

FIG. 2R illustrates a notes screen which may be displayed in response to the SCO selecting a notes button 280. The notes screen may output a list of all general notes associated with the student. The notes may be automatically generated by the platform or may be added by the SCO. The notes screen provides a view note button 282 which the user may select to view the details of the note, and a new note button 284 which the user may select to create a new general note for the student.

FIG. 2S illustrates a log page which may be displayed in response to the SCO selecting a log button 286. The platform may generate logs in response to the SCO taking any action regarding the student within the platform. For example, the platform may generate a log in response to the SCO adding the student to the platform, creating a new document, revising a document, adding notes, editing the student profile, editing the student tasks, editing the semester information, or taking any of a number of actions related to the student using the platform. In some embodiments, the platform may also generate logs in response to receiving signals from an external device or system (e.g., may generate a log in response to new grades being added by a school server or in response to a new scholarship being awarded to the student). These logs may be generated automatically in response to the SCO taking the actions, and each of these logs may be viewable in the log page. Should the SCO wish to view additional details regarding any of the log entries, the SCO may select a log entry details button 288 associated with the desired log.

FIG. 2T illustrates a log details window 290 which may be displayed for a selected log in response to the log entry details button 288 of FIG. 2S being selected. The log details may include at least one of: a list of changes made by the SCO; the old values (if the log entry was for editing a field); or the new values. For example, the log details window 290 shows that the SCO changed the student's phone number and provides the old phone number and the updated phone number.

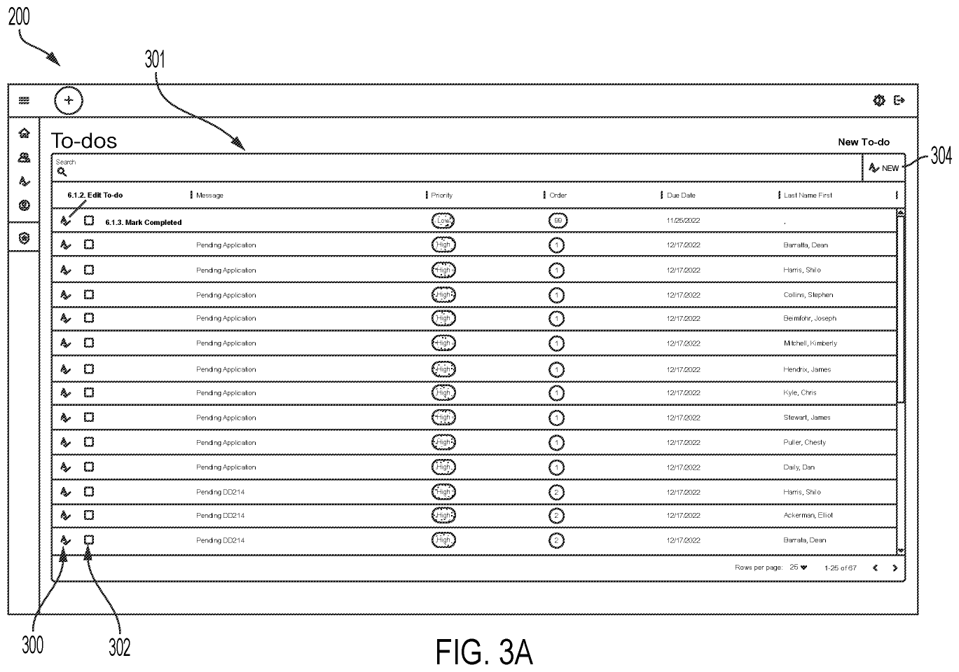

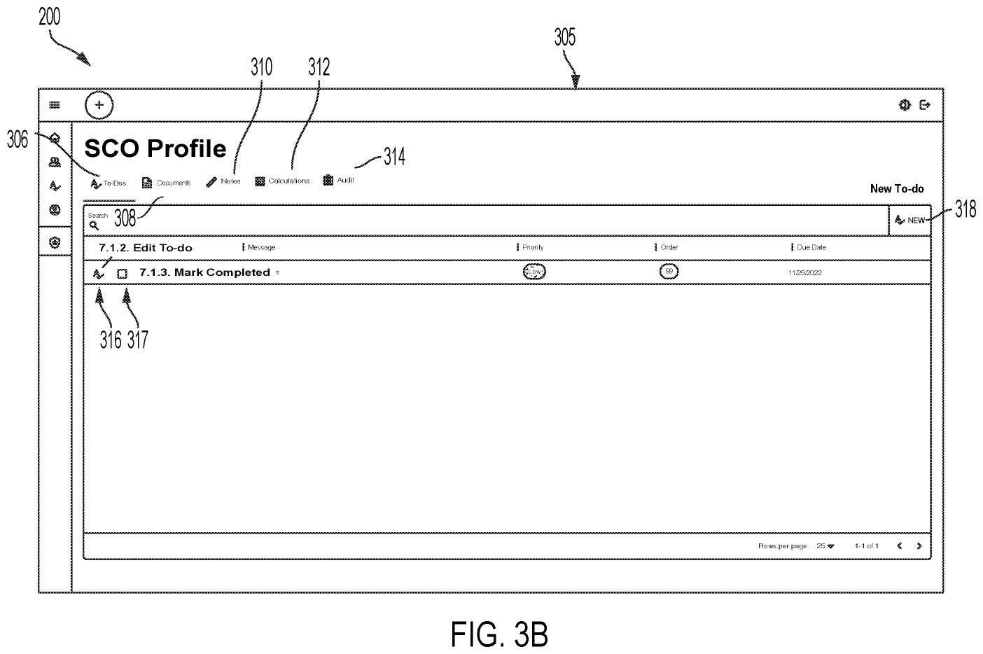

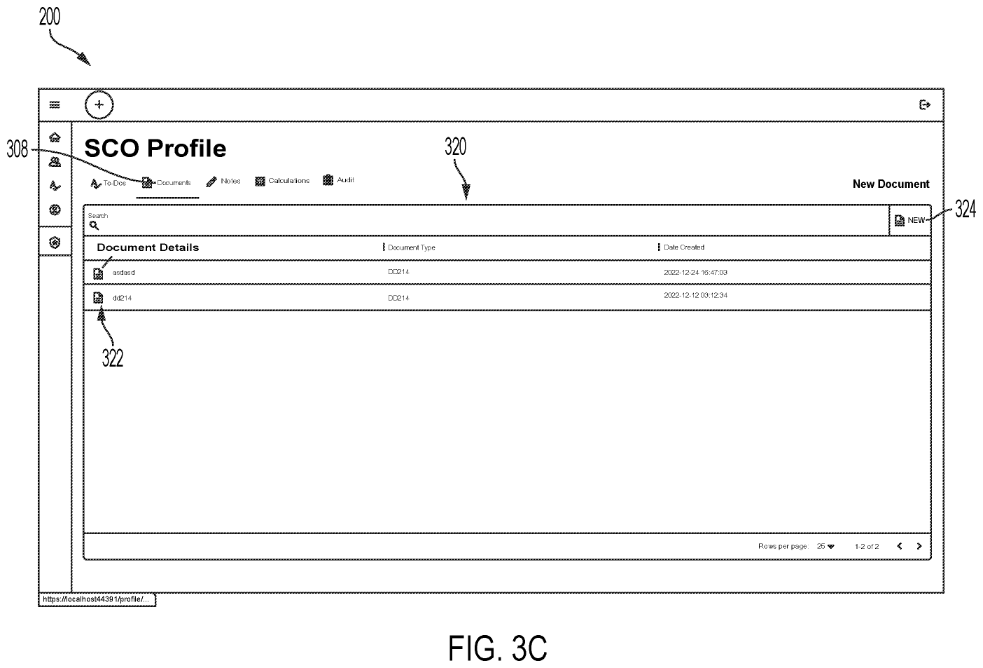

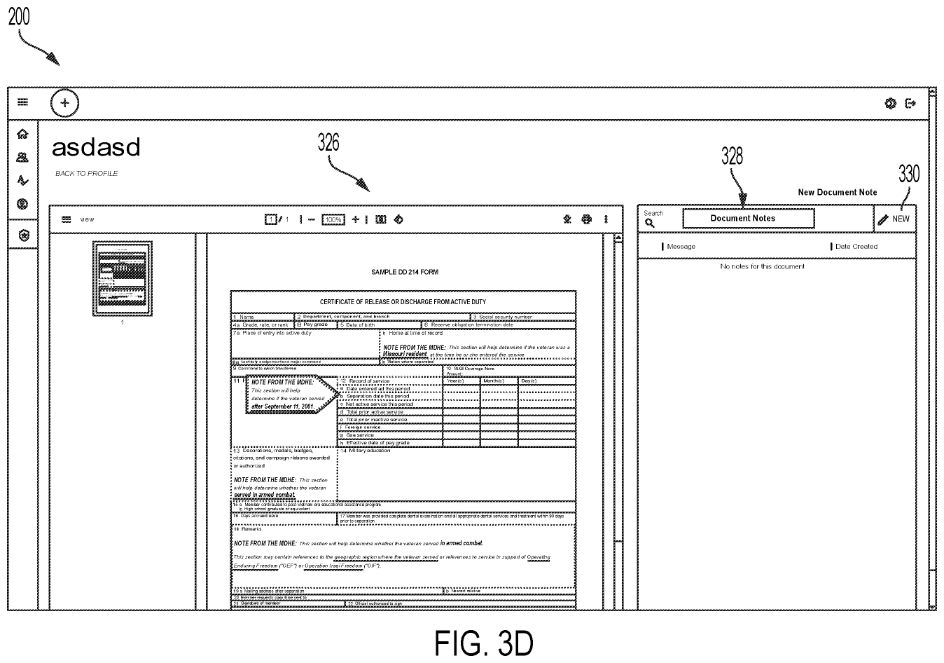

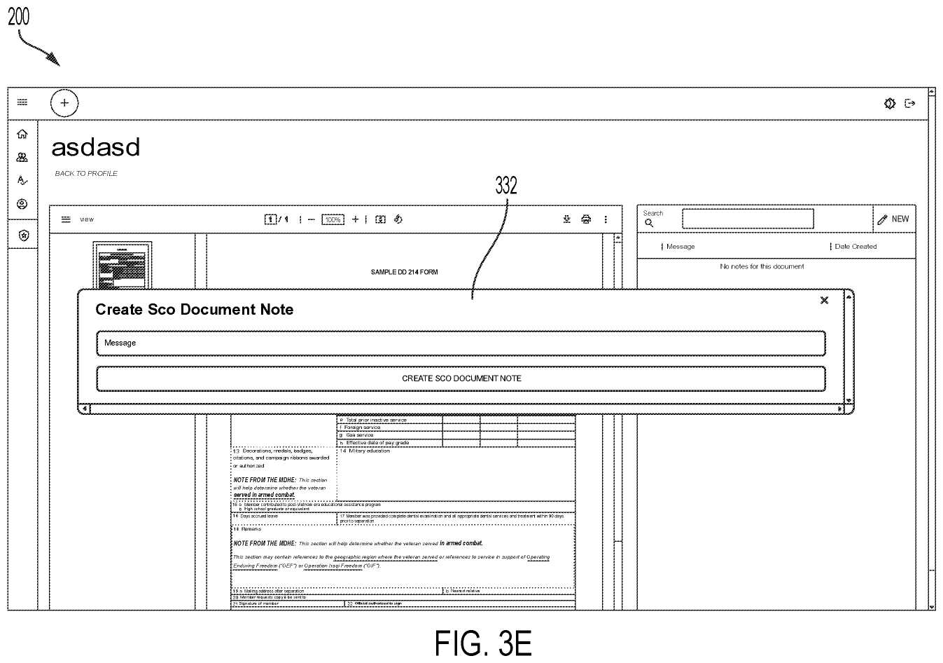

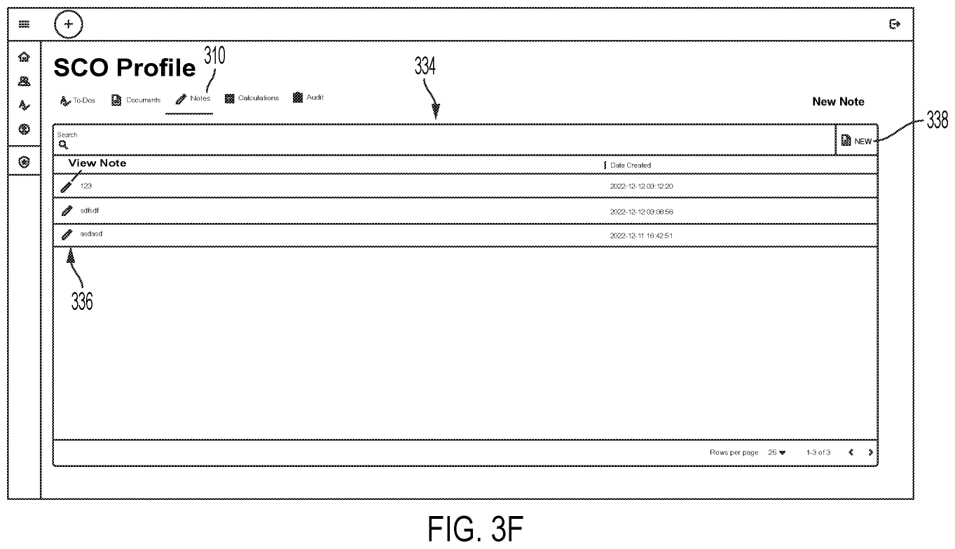

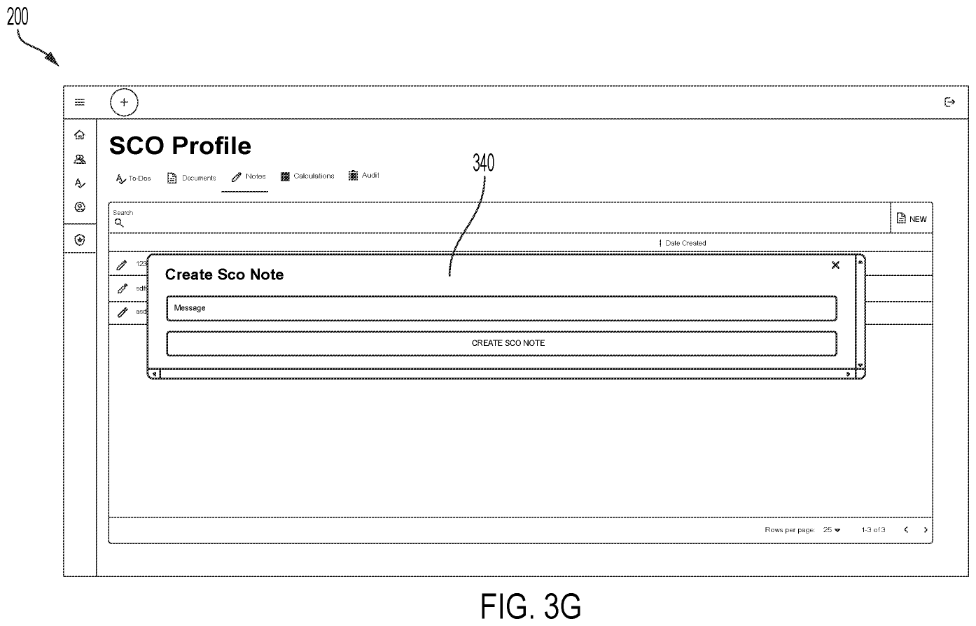

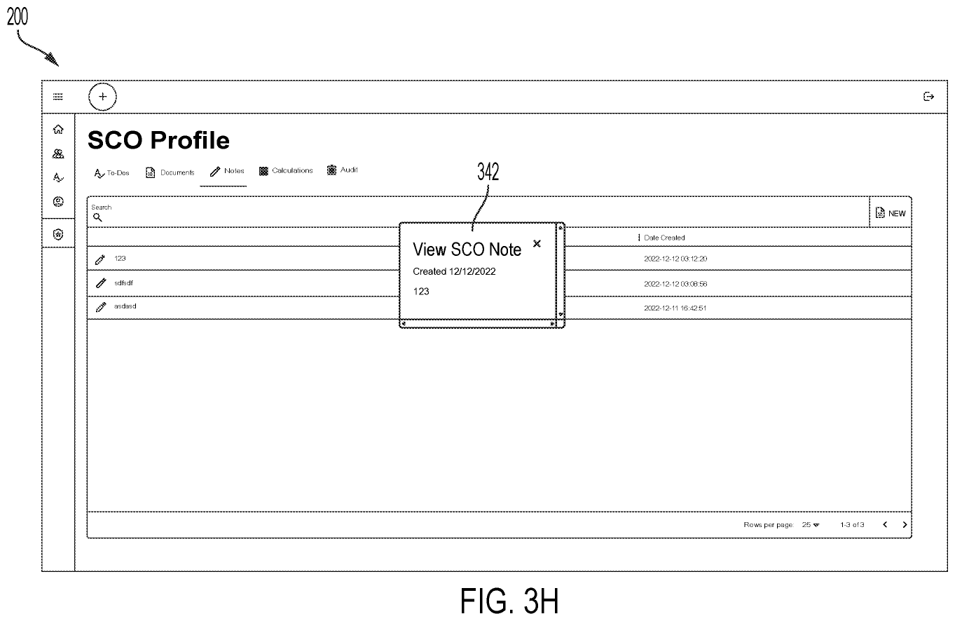

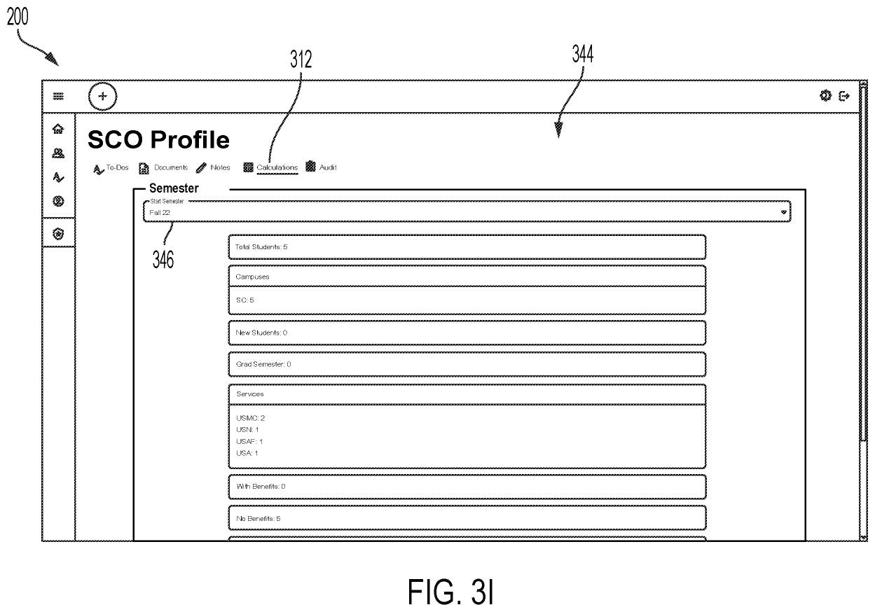

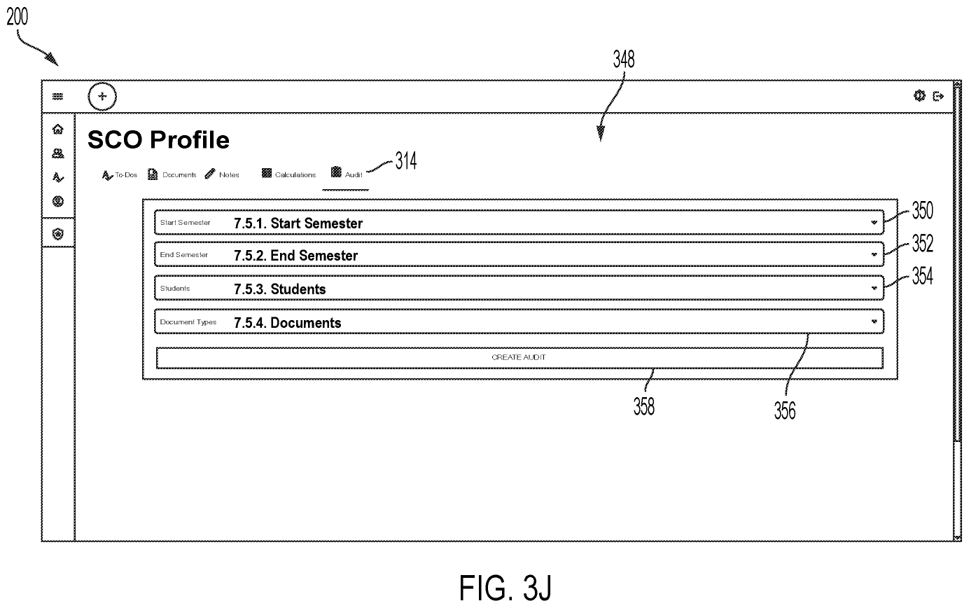

Referring briefly to FIGS. 3A through 3J, various portions of the UI 200 related to an SCO (as opposed to students as in FIGS. 2A through 2T) are shown. The portions of the UI 200, or platform, related to the SCO may be edited by the SCO. In some embodiments, a supervisor of the SCO may have access to the platform and may edit the portions of the platform related to the SCO; for example, the supervisor may be a government worker in charge of multiple SCOs at one or more school. Providing access to SCO information to a supervisor of the SCO may assist the supervisor in transferring responsibilities of the SCO to another SCO in response to retirement or a job change by the SCO.

FIG. 3A illustrates a list of tasks 301 that are assigned to a given SCO. For example, an SCO may open the list of tasks 301 that are assigned to the SCO in order to identify tasks that must be, or should be, completed by the SCO. The tasks may be automatically populated by the platform (e.g., if the platform is aware of registration dates for an upcoming semester then the platform may create a new task to ensure all students have registered for classes for the upcoming semester), may be populated by the SCO (e.g., by creating a new task), or the like. In some embodiments, the platform may be programmed to learn, or may learn independently, for which types of actions the SCO creates new tasks for, and may generate new tasks when new actions occur which have been previously associated with new tasks. As shown, the list of tasks 301 may include information such as a message regarding the task (e.g., a summary of the task), a priority of the task, an order of the task (e.g., the SCO may assign an order to the various tasks, or the platform may assign the order to the tasks), a due date of the task, and a student with which each task is associated. In some embodiments, the list of tasks may include any additional or alternative information for some or all tasks.

The list of tasks 301 may include edit task buttons 300 that are each associated with a specific task. An edit task button 300 may be selected by the SCO in order to edit various information associated with a respective task. For example, if the SCO wants to change a priority or a due date of a specific task then the SCO may do so by selecting the edit task button 300 for the respective task. As another example, the edit task button 300 may be used by a supervisor to assign the task to a new SCO. The list of tasks 301 may also include mark completed buttons 302 that are each associated with a specific task. In response to a task being completed, the SCO may select a mark completed button 302 that is associated with the respective task. The platform may remove the task from the list of tasks 301 in response to the mark completed button 302 being selected; however, the task may be saved by the platform for a period of time. Furthermore, a log regarding the removal of the task may be stored in the platform logs. The list of tasks 301 may also include a new task button 304. The new task button 304 may be used by the SCO to create a new task to be added to the list of tasks. The SCO may be able to create a new task using language selected by the SCO, may select a task from a predetermined list of tasks that is provided by the platform, or the like.

Turning to FIG. 3B, an SCO profile interface of the UI may provide options for the SCO (or a supervisor of the SCO with access to the platform) to view, add, remove, or change information associated with the SCO. The SCO profile interface may include various buttons which may be selected by the SCO to view associated windows. For example, the SCO may be able to interface with tasks associated with the SCO by selecting a task button 306, to interface with documents associated with the SCO by selecting a documents button 308, and to interface with notes associated with the SCO by selecting a notes button 310. The SCO may further be able to interface with calculations by selecting a calculations button 312, and to interface with one or more audit by selecting an audit button 314.

FIG. 3B illustrates a tasks window 305 which lists tasks associated with the SCO. The tasks window 305 may include similar features as the list of tasks 301 shown in FIG. 3A. In particular, the tasks window 305 may show a list of all active tasks associated with the SCO (i.e., tasks that have not been marked as completed and which are associated with the SCO). In some embodiments, the tasks window 305 may provide the user with an option to view all closed tasks, or all open and closed tasks together. The tasks window 305 may include an edit task button 316 associated with each listed task. The SCO may edit any information for a selected task by selecting the edit task button 316 and changing the value(s) or other information. The tasks window 305 may further include a mark task completed button 317 associated with each listed task. The SCO may mark any of the tasks as completed by selecting a mark task completed button 317 for the respective task. As previously mentioned, the task may be removed from the list of tasks but may remain stored by the platform, and a log of the completion may be stored. The tasks window 305 may further include a new task button 318. The new task button 318 may be used by the SCO to create a new task to be added to the list of tasks. The SCO may be able to create a new task using language selected by the SCO, may select a task from a predetermined list of tasks that is provided by the platform, or the like.

Turning to FIG. 3C, an SCO documents window 320 may be displayed by the UI 200 in response to the SCO selecting the documents button 308. The SCO documents window 320 may output a list of documents that are associated with the SCO. For example, these documents may be uploaded by the SCO or assigned to the SCO by another user (e.g., a system administrator or other supervisor of the SCO). In the SCO documents window 320, a supervisor of the SCO may assign the documents to a new SCO, for example, if the current SCO is switching jobs or retiring. The document information may include an identifier of the document, a type of the document, and a date in which the document was created or added to the platform (or associated with the SCO). The SCO documents window 320 may include a document details button 322 for each document that is listed in the SCO documents window 320. The SCO may select the document details button 322 associated with a desired document in order to view details regarding the desired document. The SCO documents window 320 may further include a new document button 324. The SCO may create, upload, or otherwise associate a new document with the platform using the new document button 324. For example, the SCO may scan a document and upload it to the platform using the new document button 324. The SCO may use the UI 200 to provide additional details regarding an uploaded new document such as an identifier of the document, a type of the document, a student for which the document is associated, a semester or semester block for which the document is associated, or the like.

Referring to FIGS. 3C and 3D, a document details window 326 may be displayed for a selected document in response to the SCO selecting a respective document details button 322. The document details window 326 may output a copy or representation of the selected document such that the SCO may view the entire document. The document details window may also output document notes 328 associated with the selected document. These notes may be notes that are created by the SCO, notes that are automatically created by the platform (e.g., the notes may indicate a source of the document as determined by the platform), or the like. The document details window 326 may also include a new note button 330. The SCO may select the new note button 330 to create a new note and have the note associated with the selected document. In some embodiments, the SCO may click on a selected note from the notes 328 to edit the note. In some embodiments, the SCO may delete the note in a similar manner.

Referring to FIGS. 3D and 3E, a new document note window 332 may be displayed in response to the SCO selecting the new note button 330. In some embodiments, the SCO may create template notes and may create a new note using a pre-designed template template, may create a new note from scratch, may select from a template provided by the platform, may select a completed note provided by the platform, or the like.

Turning to FIG. 3F, a notes window 334 may be displayed in response to the SCO selecting the notes button 310. The notes window 334 may list general notes created by, or associated with, the SCO (as opposed to FIG. 3D which shows notes associated with a specific document). In some embodiments, the notes window 334 may also list specific notes such as notes associated with a specific task, notes associated with a specific document, or the like. The notes window 334 may list each of these notes along with a summary or description of the note and a date in which the note was created. The notes window 334 may include a view note button 336 associated with each of the notes such that the SCO may view details regarding the note in response to selecting a respective view note button 336. The notes window 334 may further include a new note button 338 which provides an opportunity for the SCO to create a new note.

Referring to FIGS. 3F and 3G, a create new note window 340 may be displayed in response to the SCO selecting the new note button 338. The new note window 340 may provide an option for the SCO to create a new note from a template, from scratch, automatically using the platform (e.g., the SCO can provide some information and the platform can use the information along with a template to finalize creation of a note), or the like. In some embodiments, the SCO may associate the new note with a particular element (e.g., a document, a task, or the like) using the new note button 338.

Referring to FIGS. 3F and 3H, a view note window 342 may be displayed in response to the SCO selecting a view note button 336 for a specific note. The view note window 342 may show the entire note that was created, along with a date of creation and any modifications or edits to the note. In some embodiments, the view note window 342 may further show a source of the note (e.g., whether the note originated from the SCO, from an administrator, from the platform (e.g., automatically in response to an event occurring), or the like).

Turning to FIG. 31, a calculations window 344 may be displayed in response to the SCO selecting the calculations button 312. The calculations may show specific calculations, statistics, or other data associated with the SCO. For example, the calculations may illustrate a real-time snapshot of specific information as requested by the SCO, such as a snapshot of students, benefits, and scholarships applied to all students assigned to the SCO for a given semester. In some embodiments, the calculations may be output for a selected semester. In that regard, the SCO may select a specific semester using a semester selection button 346 and selecting a desired semester. The calculations may include, for example, a quantity of students assigned to the SCO, campuses on which the students are located, a list of services the students were enrolled in (e.g., the Marine Corps, the Navy, etc.). The SCO may use the semester selection button 346 to select any previous, current, or future semester to view the calculations for the selected semester.

Turning now to FIG. 3J, an audit window 348 may be displayed in response to the SCO selecting the audit button 314. The SCO may utilize the audit window to create an audit based on various criteria. For example, an audit may include notes regarding students, documents related to students, student activity logs, documents related to the SCO, and the like. In some embodiments, the SCO may customize information to be included in an audit based on specific requirements of the SCO. For example, a supervisor of the SCO may require that audits include all student documents, activities related to the documents, a list of all benefits, information related to payment of the benefits, and student grades, all for the previous 2 years. In that regard, the SCO may instruct the platform to include all of this information in audits, and may then run audits automatically that include all of this information. In some embodiments, the SCO can specify a format for the audits, and the platform will create the audit information in the specified format.

In some embodiments, the platform may be designed to include a set portion of information in the audit that is based on requirements of all SCOs. In some embodiments, an audit may include a set portion of information and additional information as customized by the SCO. This is advantageous because audits are required from time to time, and in conventional setups, SCOs had to manually create audit documents by retrieving and reviewing old documents and notes, performing calculations, and creating audit documents from scratch. Because the old audits were performed by hand, the opportunity for mistakes was relatively great, which occasionally resulted in the school losing funding from the federal government for the veteran(s) studying at the school. Furthermore, because audit documents were created manually, audits from different SCOs had vastly different formats, making review of the audit documents relatively difficult for reviewers. That is, supervisors that have multiple SCOs working for them may receive audits having vastly differing information and formats, making review of the audits and SCO performance relatively difficult.

The platform, on the other hand, retrieves information provided by at least one of the SCO, the platform, or another source and automatically generates audits using this information. This reduces the likelihood of mistakes in the audit, ensures accurate representation of information in the audit, and creates audits having a standardized formatting. In some embodiments, the SCO may instruct the platform to add or remove certain information and to adjust the formatting based on specific desires of the SCO, as well as information requested by a supervisor of the SCO or a reviewer of the audit document.

The SCO may use the audit button 314 to generate a new audit document at any time. In the audit window 348, the SCO may select parameters of the specific audit and then request generation of the audit document. For example, the SCO may select a starting semester for the audit using a starting semester button 350. The SCO may also select an ending semester for the audit using an ending semester button 352. The starting semester button 350 and the ending semester button 352 may allow the SCO to select from any of the semesters for which the SCO has information stored in the platform. The SCO may also select one or more students to be included in the audit document using a student button 354. The selectable information in the student button 354 may include any parameters allowing the SCO to select students by: individual student name, branch of military service, class year of the student, major of study of the student, students with acceptable grades or unacceptable grades, or the like. This may be useful, for example, if only one branch of service is requesting an audit—the SCO may select all students that are veterans of the specific branch of service (e.g., the army; or may make a selection of the specific branch such that the platform selects the specific students) and may leave the remaining students out of the audit. The SCO may further select one or more type of document to be included in the audit using a document selection button 356. For example, certain audits may only require documents of a certain type. In these cases, the SCO may select only the desired types of documents to be included in the audit document. After defining the parameters of the audit using the buttons 350, 352, 354, 356, the SCO may select a create audit button 358 to generate the audit document using the parameters selected by the SCO.

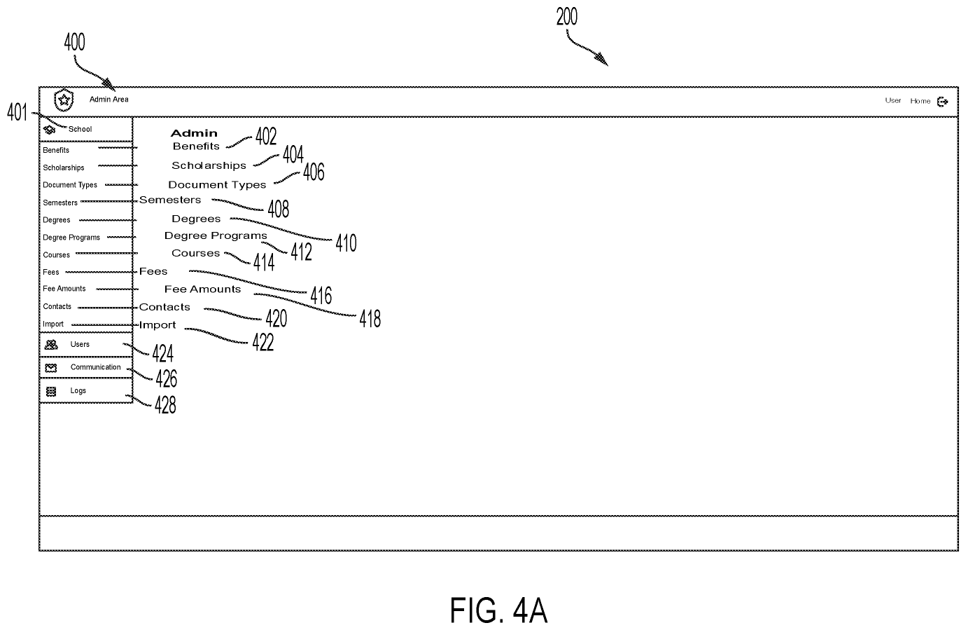

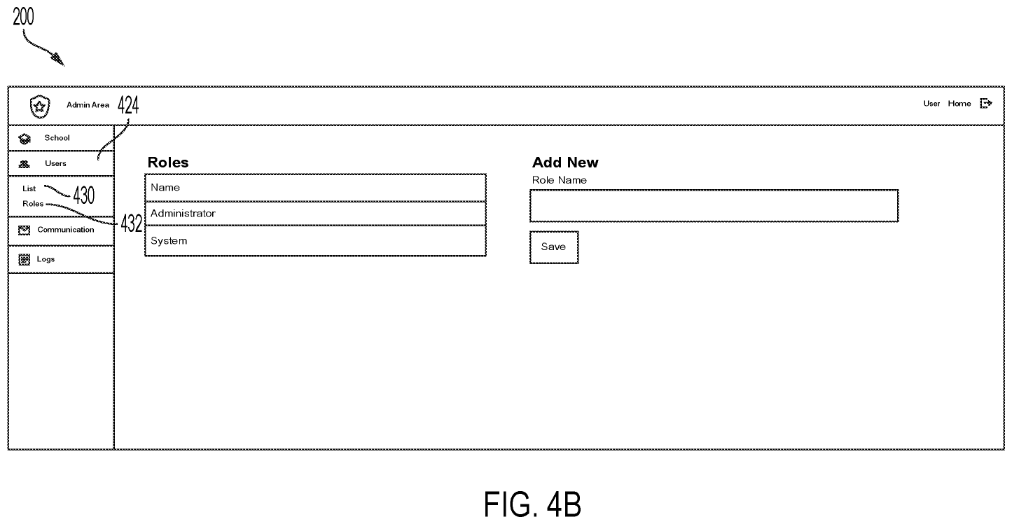

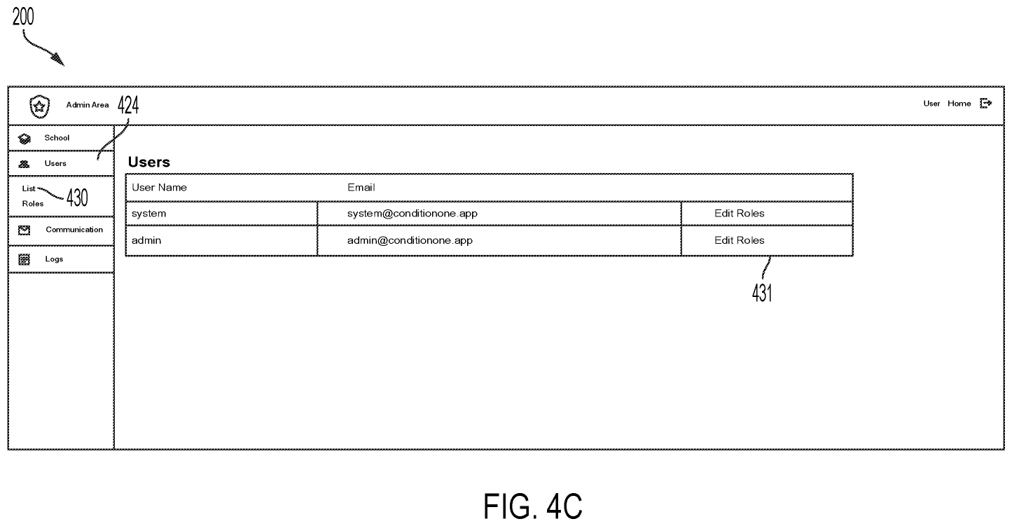

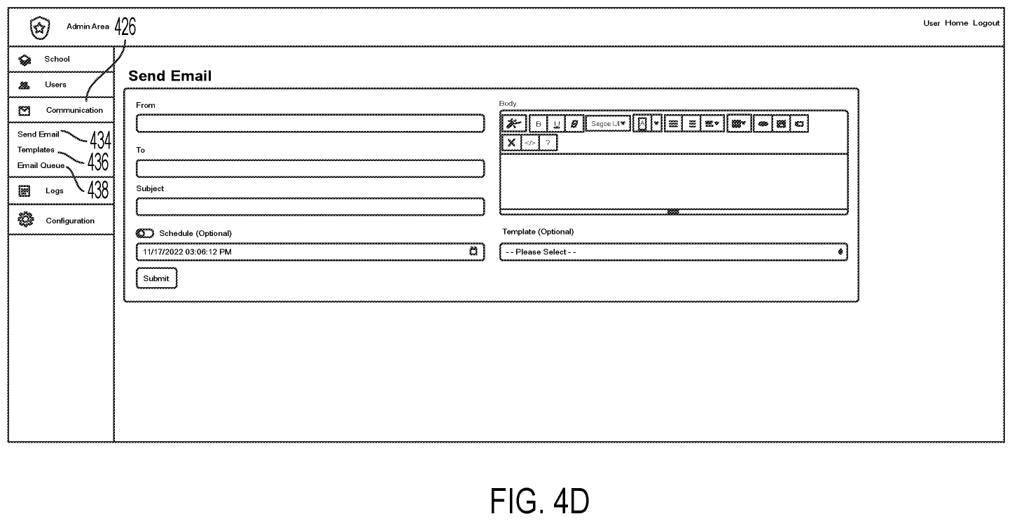

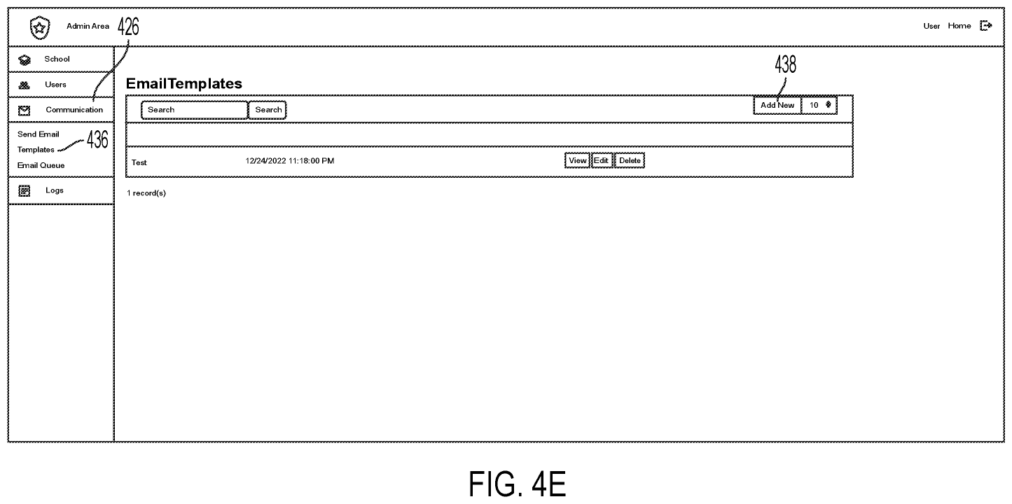

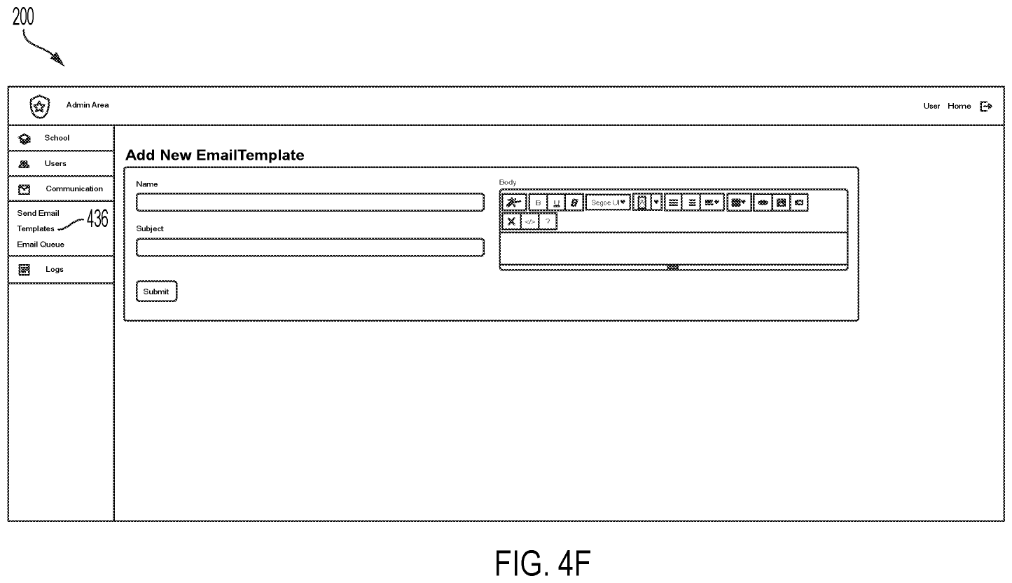

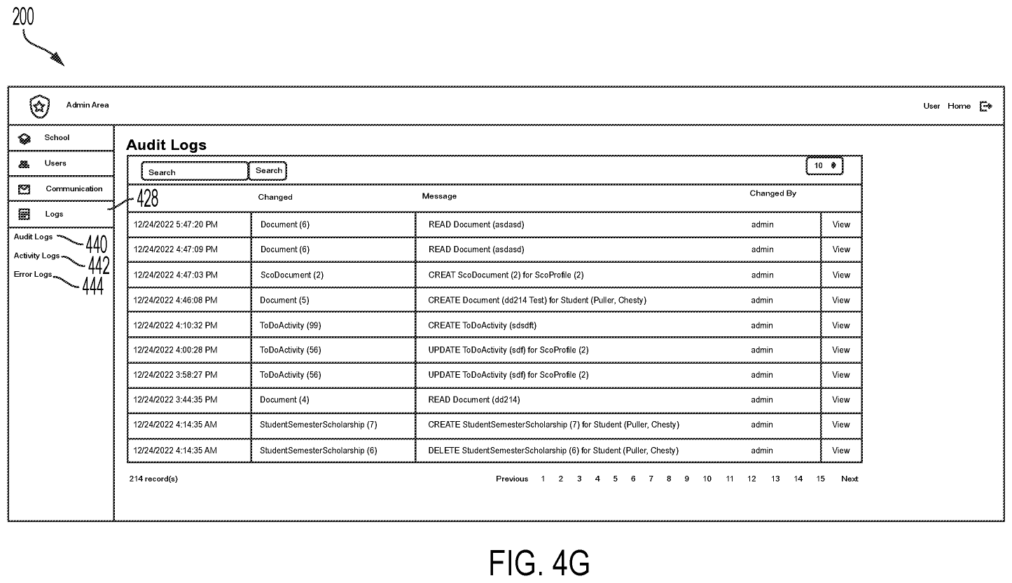

Referring briefly to FIGS. 4A through 4G, various views of the UI 200 relating to an administrative area 400 of the platform are shown to illustrate various features of the platform that are available to a system administrator (system admin). The administrative area 400 may be available only to system users that are identified as system administrators. For example, a system administrator may be a government employee to whom one or more SCO reports, a school official in charge of managing SCOs, a technical team responsible for upkeep of the platform, a senior SCO responsible for junior SCOs, or the like. As will be shown further below, administrative rights may be provided to new or existing users by a present administrator. In some embodiments, a lead SCO may be provided with administrator rights and may thus act as a system admin. In some embodiments, a supervisor of an SCO may be identified as the system admin.

Referring to FIG. 4A, a view of the UI 200 illustrates identifiers of actions that may be taken by a system admin. The actions may be divided into four categories which may be accessed by clicking on a respective button. In particular, some of the actions relate to features of the school at which the platform is in use and may be accessed by selecting a school button 401. A list of actions related to the school, along with respective buttons, may be displayed in response to selection of the school button. These may include a benefits button 402, a scholarships button 404, a document type button 406, a semesters button 408, a degree button 410, a degree programs button 412, a courses button 414, a fees button 416, a fee amounts button 418, a contacts button 420, and an import button 422.

Some of the actions may relate to users of the platform, and may be accessed by selecting a users button 414. In addition, some of the actions may relate to communications using the platform and may be accessed by selecting a communication button 426. Some additional actions may relate to logs and may be accessed by selecting a logs button 428. The specific actions related to the users may be displayed in response to selection of the users button, specific actions related to the communications may be displayed in response to selection of the communication button 426, and specific actions related to the logs may be displayed in response to selection of the logs button 428.

The system administrator may have the rights and ability to change values within one or more specific instance of the platform. For example, benefits that are available to students at the specific school, which may include benefits available to all students, some students, or veterans, may be accessed using the benefits button 402. The administrator may be able to add benefits, remove benefits, or modify aspects of specific benefits using the benefits button 402. In that regard, the available benefits, as modified by the administrator, may be selected by an SCO when using the platform to add benefits for a specific veteran student.

The system admin may also add, remove, or modify scholarships that are available to students using the scholarships button 404. For example, the school may start offering a new scholarship and the system admin may add the scholarship as an available option using the scholarships button 404. The new scholarship may then be available for any SCO at the school to access and indicate as awarded to a veteran student.

The system admin may also be able to add, remove, or modify document types using the document type button 406. In that regard, any document stored or identified by the platform may be edited to be assigned to a specific document type that has been added or approved by the system admin.

The system admin may also be able to add, remove, or modify semesters using the semesters button 408. For example, as a new semester is approaching, the system admin may add information relating to the new semester to the platform using the semesters button, and the new semester may afterwards be available for inclusion by any SCO.

The system admin may also be able to add, remove, or modify degrees using the degrees button 410. For example, if the school decides to stop offering Ph.D. programs, the system admin may remove Ph.D. programs from the school's instance of the platform using the degrees button 410, removing the ability for SCOs to assign students as Ph.D. students.

The system admin may further be able to add, remove, or modify degree programs using the degree programs button 412. For example, if the school starts offering one or more degree in nuclear engineering, the system admin may add nuclear engineering as a degree.

The system admin may also be able to add, remove, or modify courses using the courses button. For example, if the school removes some English literature classes, then the system admin may remove the English classes as available course options.

The system admin may also be able to add, remove, or modify fees using the fees button 416. For example, if the school adds a new on-campus living fee to cover electricity costs then the system admin may add a living fee as an optional fee in the school's instance of the platform.

The system admin may also be able to add, remove, or modify fee amounts using the fee amounts button 418. For example, if the school increases tuition for an upcoming semester, the system admin may modify the tuition value in the school's instance of the platform to be equal to the new tuition cost.

The system admin may also be able to add, remove, or modify contacts using the contacts button 420. For example, if the school hires a new dean for engineering (or hires a new SCO), then the system admin may add a new contact item for the new dean (or for the new SCO).

The system admin may also be able to add, remove, or modify options for importing documents in the system using the import button 422. For example, the system admin may provide permission to import contact information that is stored in a text document.

As described here, only a system admin may change options that are available for certain values within the platform. This may reduce the likelihood of mistakes in any records compiled or otherwise created by an SCO by removing the ability of the SCO to add new values that do not exist at the specific school.

Referring to FIGS. 4B and 4C, actions that may be taken by a system admin that relate to users of the instance of the platform at the specific school are described. As shown, in response to selecting the users button 424, additional options include outputting a list of users using a list button 430 and outputting a list of available roles using a roles button 432. FIG. 4B illustrates the result of selecting the roles button 432. As shown, the available roles include an administrator role and a system role. The system admin may add any additional roles that make sense, such as a supervisor role, a junior SCO role, or the like. The system administrator may also set actions that are allowed to be taken by each role, and actions which may not be taken by each role. For example, a junior SCO may not be able to remove a student, while a more senior SCO may have this ability. FIG. 4C illustrates the result of selecting the list button 430. As shown, a list of users of the specific instance of the platform is shown. The list may also provide contact information for the users, as well as an option to edit the roles of each specific user. For example, a user may be assigned admin rights using an edit roles button 431.

FIGS. 4D through 4F illustrate actions that may be taken by a system admin that relate to communications. These options may be provided in response to selection of the communication button 426, and may include sending an email using a send email button 434, changing email templates using a templates button 436, and checking an email queue using an email queue button 438. FIG. 4D shows the result of selecting the send email button 434. In particular, a user may select a source of the email and a recipient of the email, may identify a subject, may schedule the email to be transmitted at a later date and/or time, may type a message, and may select a template for the email. FIG. 4E illustrates email templates that may be shown in response to selection of the templates button 436. In particular, the user may search for an email template and select any template from the list. The user may also view, modify/edit, or delete any of the email templates in this window. The user may also select an add new template button 438 to create a new template that will show up in the list of FIG. 4E. FIG. 4F shows the result of selecting the new email template button 438. In particular, the user may create a name for the template (e.g., “Messages to College of Engineering dean”), may create a subject for the template, and may type a message for the email body. The email template may then be available for the user or other users to access at a later point in time.

In some embodiments, the platform may automatically generate and send emails. For example, the platform may be provided with (or learn) a plurality of trigger events that each correspond to a specific event (e.g., a grade point average of a student dropping below a predetermined threshold level, a quantity of semester hours for a student being less than an allowed quantity based on a scholarship awarded to the student, enrollment status of a student being changed by an entity other than an SCO (such as by a school server), or the like). The platform may be provided with a desired format and content for each trigger or type of trigger (e.g., the content may include the student's grade point average and the required grade point average, the content may include a quantity of semester hours for a student and requirements of a scholarship assigned to the student, etc.). In response to the trigger occurring, the platform may automatically generate an email having the content and format, and may automatically send the email to a target recipient (e.g., an SCO, a supervisor, the student, or the like). In some embodiments, the platform may include the trigger event and the triggering information.

In some embodiments, the tasks assigned to the SCO may include a corresponding due date. The platform may be programmed to check the status of each task and its associated due date periodically or from time-to-time. A trigger may include an open task (i.e., a task that has not yet been marked as complete) that has a due date of the present date or a previous date. In that regard, the platform may automatically generate and send an email to the SCO indicating the specific task, the due date of the task, and the status of the task (i.e., the task being open).

The system admin may also view all system logs by selecting the logs button 428. The types of logs may include audit logs 440 relating to logs that are to be reported in an audit, activity logs relating to logs for activities that have occurred in the platform, and error logs 444 relating to errors that have occurred in the platform. In response to selecting a type of log, the logs will be displayed in the UI 200. The system admin may be able to view details for any of these logs in the window shown in FIG. 4G. In some embodiments, the system admin may be able to search for specific logs (e.g., error logs that occurred on a specific date at a specific time). In some embodiments, the system admin may be able to generate a list of logs based on specific criteria identified by the system admin (e.g., all changes made by User 1). The system admin may also be able to generate audit data usable in an audit using the window shown in FIG. 4G relating to logs.

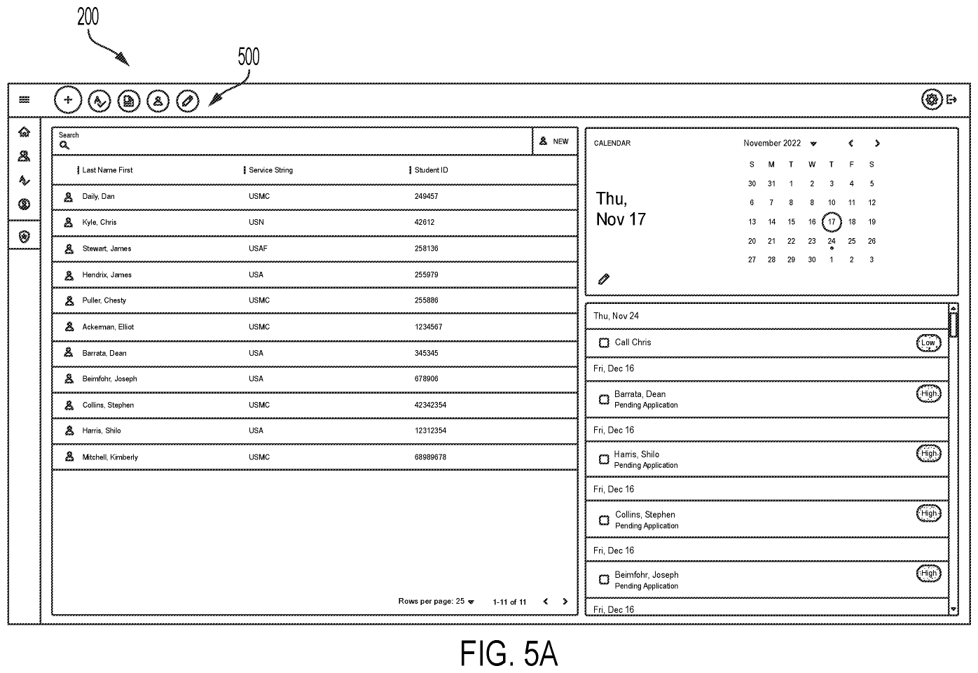

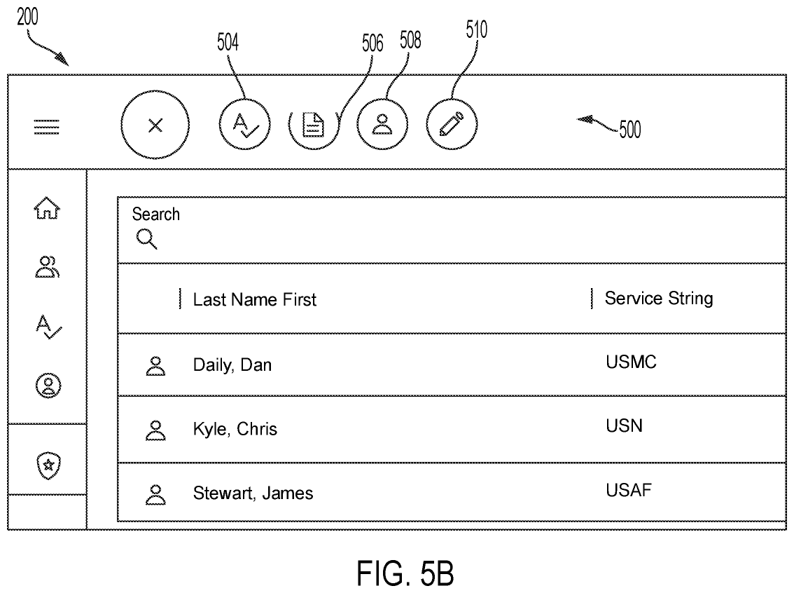

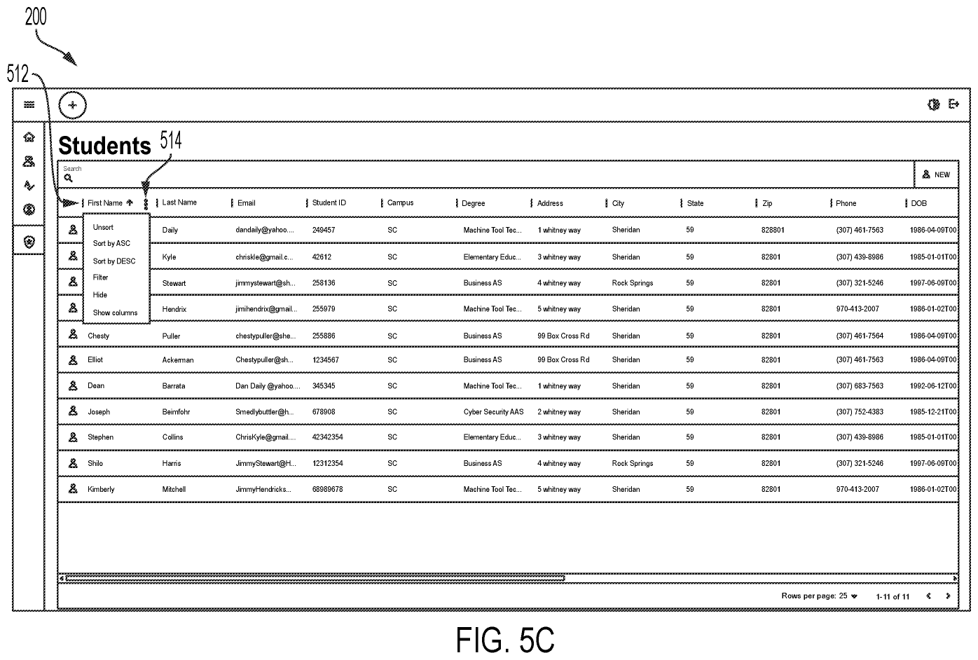

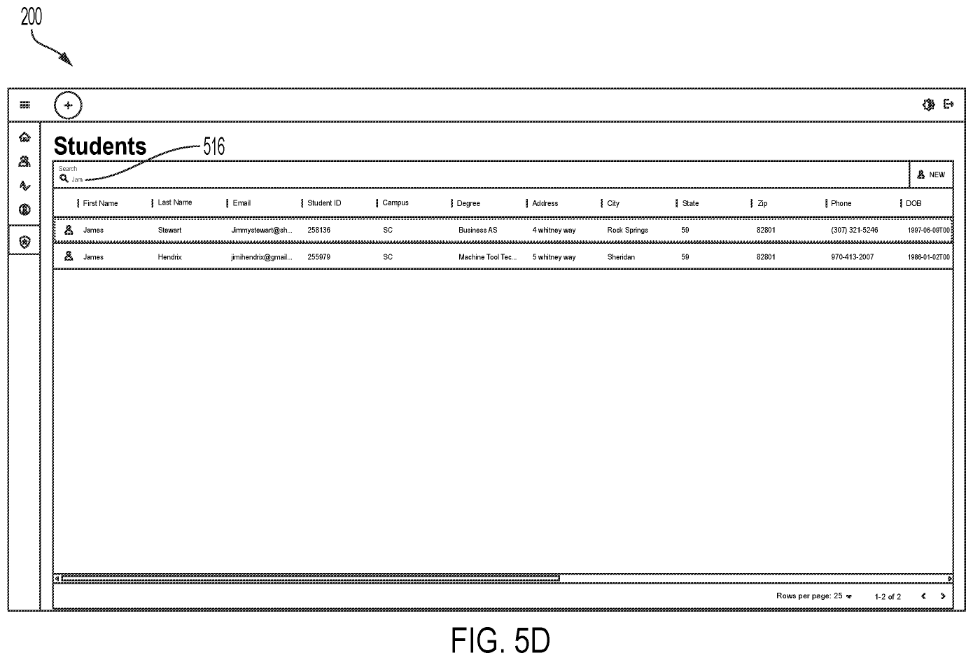

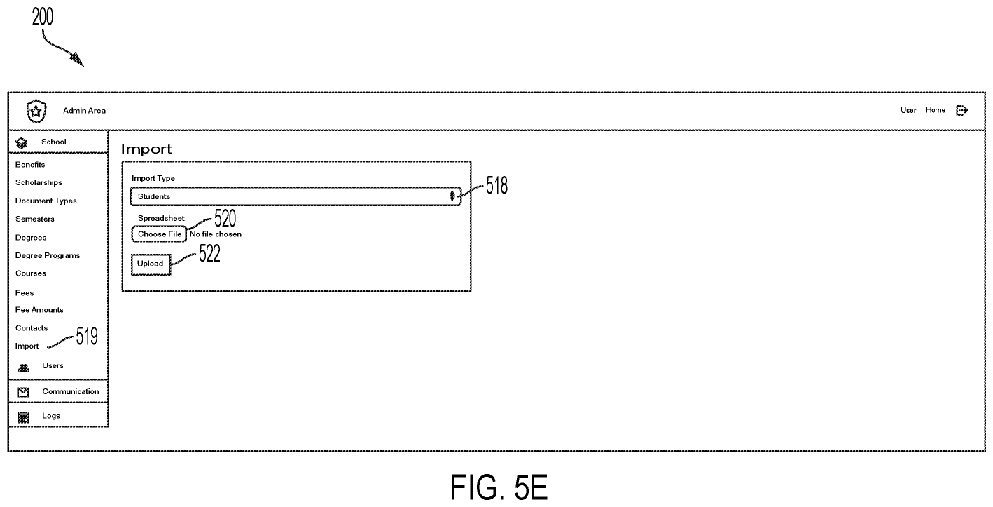

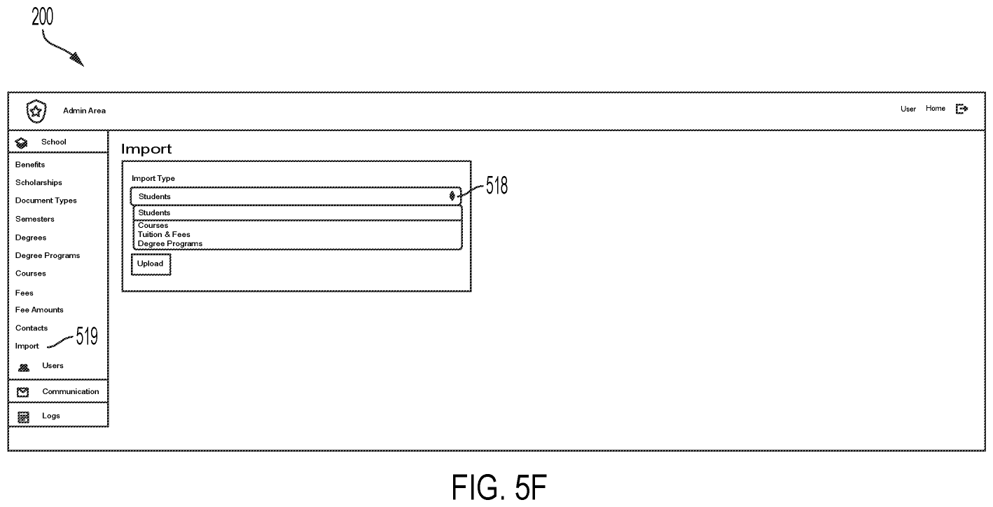

Referring briefly to FIGS. 5A through 5F, additional details of the platform are shown as available using the UI 200. The features discussed with reference to FIGS. 5A and 5B may be generally applicable to various portions of the UI 200. As illustrated in FIGS. 5A and 5B, a similar summary page of students as the summary page of FIG. 2A is shown. The summary page may include a list of students, a calendar, and a list of tasks. The information in FIGS. 5A and 5B may relate to a specific SCO or may generally relate to all SCOs for a school. As shown in FIGS. 5A and 5B, a list of actions 500 is shown. These actions may be taken by an SCO in any one or more portions of the UI 200. In some embodiments, these actions may include shortcuts (e.g., to a specific function, such as a documents function), may include actions to take (e.g., initiate a spell-check program), or the like. The embodiment illustrated in FIGS. 5A and 5B includes a first button 504 to open a list of tasks assigned to the SCO. This embodiment includes a second button 506 to go to a documents page, which allows the SCO to review an existing document, add a new document, or the like. This embodiment also includes a third button 508 which pulls up a full list of students assigned to the SCO. This embodiment further includes a fourth button 510 which allows the SCO to add a note; the note may be added at a specific window which is already shown on the UI 200 or may link the user to a list of general notes.

Turning to FIG. 5C, additional general actions available on the platform via the UI 200 are shown. As shown, the UI is on a list of students page in FIG. 5C, and the list includes various columns (e.g., for student first name, student second name, email address, etc.). A first row of the table includes labels 512 which may also function as a button. By selecting a label 512 for one of the columns, a menu 514 appears. The menu 514 may include options that are available for the specific table. For example, the options may include sorting the list contents, filtering the list, hiding the column, showing all columns, or the like. Similar options may exist for all lists. In that regard, the SCO can manipulate the various lists and information in any desirable manner.

In addition, and as shown in FIG. 5D, a search bar 516 may be present in one or more locations in the UI. By typing or otherwise adding information into the search bar 516, the user may find all instances of a typed character string (e.g., “JAM” in FIG. 5D). This allows the user to further manipulate the lists as desired.

In certain situations, it may be desirable to import lists or other information into the platform rather than manually entering all of the information using the UI. In that regard and with reference to FIGS. 5E and 5F, the platform may include an import button 519 which provides an option to import information stored in an external document. For example, an import window may include a drop-down menu in which the user may select what type of information is being imported (e.g., student information, courses, tuition and fees, degree programs, or the like). A select file button 520 allows the user to select a specific file in which the information is currently stored. After selecting the type of import using the button 518 and selecting the specific file using the button 520, the user may select an upload button 522 which results in the data stored in the file being imported and categorized in the platform. For example, if the file includes a list of students and their contact information then the result of the upload will be that all the students in the list and their corresponding contact information are stored in the proper location(s) within the platform.

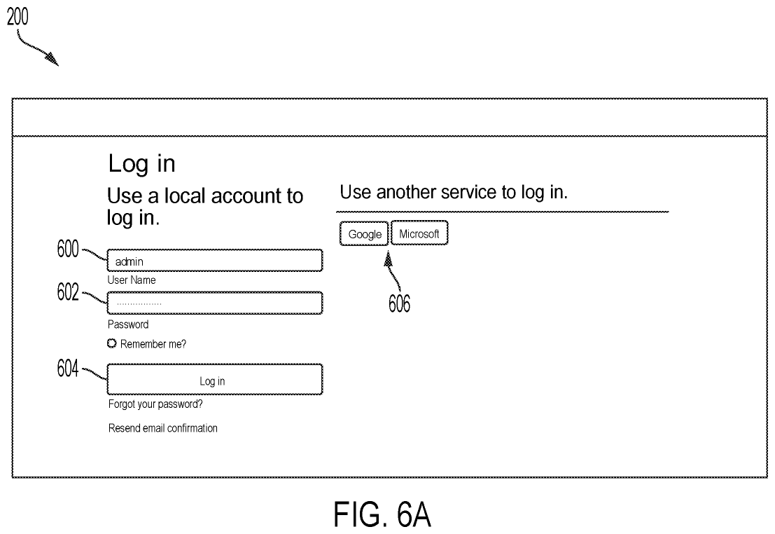

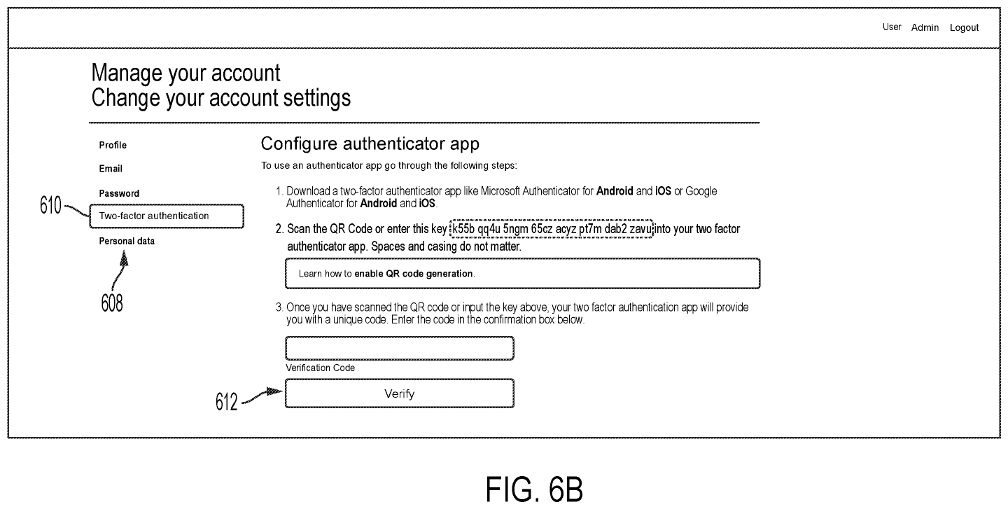

FIG. 6A illustrates a log in page which may be used by an SCO or another user to gain access to the specific implementation of the platform for which he or she is a user. The log in page may include fields 600, 602 for entering a user name and password, respectively, and a button 604 to complete the log in after the user name and password have been entered. The platform may also offer the ability to log in using another service, such as Google or Microsoft.

Turning now to FIG. 6B, some embodiments of the platform may require two-factor authentication to log into the platform or take certain other actions. In that regard, a list of management options may include buttons 608 for various elements of a user account (e.g. for profile information, contact information, passwords, etc.). These buttons 608 may include a two-factor authentication button 610. Selection of the two-factor authentication button 610 opens a two-factor authentication setup window 612. The window 612 may include instructions and inputs which the user may use to establish two-factor authentication. In that regard and returning reference to FIG. 6A, the user may be required to complete a second step to completely log in after entering the user name and password and selecting the log in button 604.

The platform may be capable of performing various actions and functions in addition to those discussed above. In particular, the platform may perform calculations related to each semester. These calculations may be based on: tuition, fees, specific information related to a given student, branch of service in which the student served, and benefits provided to the student (which may include scholarships). The platform may be capable of performing any calculation (e.g., as requested by an SCO or as programmed by a designer or system admin of the platform). For example, the platform may calculate a total amount of money spent by a specific student for a given semester based on tuition and fees as well as scholarships awarded to the student. The SCO may submit the total amount spent to the Federal Government in order to obtain reimbursement for the student for all expenditures (or may do so prior to the beginning of the semester so the Federal Government can pay for the semester).

As discussed above, the platform is capable of importing information from external documents. For example, an SCO may keep a spreadsheet with various information related to each student, and upon obtaining the platform, may wish to have this information added to the SCO's instance of the platform. For example, before obtaining access to the platform, the SCO may have maintained a spreadsheet with information related to all students to which he has been assigned. Rather than manually entering the information, the SCO may cause the platform to import the information from the spreadsheet into the instance of the platform, and to properly identify each piece of information in the process. This imported information may include, for example, students and related information, available courses at the school, tuition and fees, available degree programs, or the like.

The platform may also be capable of performing various automatic actions. For example, the platform may be designed to schedule emails to be sent at a specified future time. For example, an SCO may wish to sent congratulatory emails to each of his or her students at the end of each semester. The SCO may set up an email template that includes congratulatory language and an insertion point for the specific student's name, and may identify a date and time for the email to be generated and sent. Once the date and time have arrived, the platform may automatically generate the emails, populate the emails with any variables (e.g., student names), and send the emails. The platform may also be designed to automatically assign tasks to SCOs, and to automatically email the SCO to notify him or her of the newly assigned task. For example, an SCO may be assigned the task of confirming that each of his or her students has registered for classes at a time and date on or after registration has opened for a specific semester. The platform may automatically generate a general task to confirm registration (or may generate separate tasks, one for each student), and may automatically generate an email to the SCO notifying the SCO that the platform has assigned this new task to the SCO.

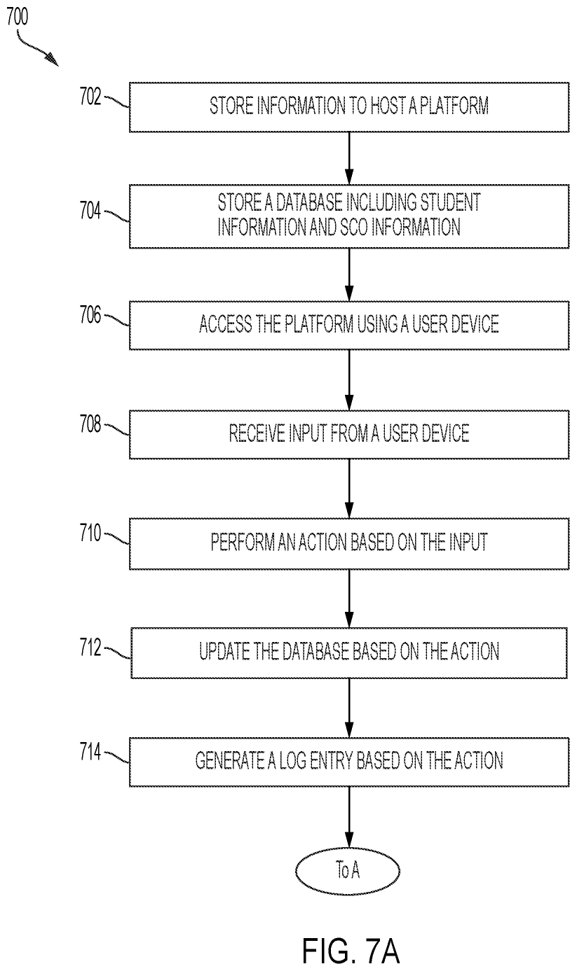

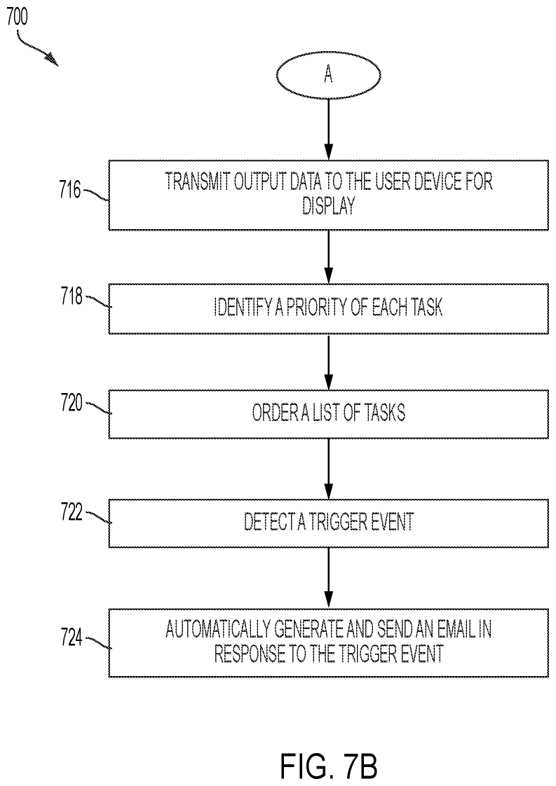

Turning now to FIGS. 7A and 7B, a flowchart illustrates a method 700 for managing responsibilities of an SCO. The method 700 may be performed using components of a system such as the system 100 of FIG. 1A. That is, the method 700 may be performed using components of an SCO system such as an SCO server, a memory or database, and one or more user devices, and one or more of these components may perform each block of the method 700. At least one of a user device or a server may include an output device that outputs a user interface that resembles the user interface shown in FIGS. 2A-6B. The functionality described above with reference to FIGS. 2A-6B may all be performed by using a method similar to the method 700.

In block 702 of the method 700, information may be stored that may be used to host a platform similar to the platform discussed herein, such as a platform for managing responsibilities of an SCO. The information may be at least partially stored in a memory of a user device, a memory of a server, a database, or the like. The information may be usable to host one or more instance of the platform. For example, the information may be stored on a memory associated with a server, and a user may interface with the platform using a user device that is in communication with the server. The information may be used to take one or more action as described herein, such as displaying a list of user tasks, automatically generating and sending emails, or the like.

In some embodiments, the information may also include information that is stored by the platform. For example, the information may include a list of tasks assigned to a specific SCO, a list of students that are assigned to the SCO, or the like. A user may be able to adjust the information stored by the platform by accessing the platform using a user device. For example, the user may add or remove a task that is assigned to the SCO. The platform may also be able to adjust this information. For example, the platform may automatically generate a task to be performed by the SCO in response to an event occurring, and may add the task to the information.

In block 704, information may be stored in a database that is associated with the platform; this information may include student information and SCO information. The student information may include a list of students and specific information associated with each student in the list of students. For example, the student information may include student grades for each student for the current semester and for any previous semester. The student information may also include a list of classes in which each student is enrolled (which may also include a list of classes which the student has already completed, along with a grade for each of these completed classes). The student information may further include a list of scholarships awarded to each student along with parameters of each scholarship (e.g., dollar amount, requirements for spending the scholarships, requirements for maintaining eligibility for the scholarship, or the like). The student information may also include benefits assigned to each student; these benefits may include monetary benefits that each student has earned from their service to the military. The benefits information may include parameters of the benefits such as a dollar amount, requirements for spending the benefits, requirements for maintaining eligibility for the benefits, or the like. The student information may further include one or more document or note associated with at least one student. For example, the documents may include a transcript from the current school, a transcript from a previous school, a marriage certificate, information corresponding to discharge from the military, letters of recommendation, or the like. The notes may include notes created and added to the platform by the SCO for any reason (e.g., to remember personal details about the student). The student information may further include a program of study in which each student is enrolled (including a degree program, such as bachelors or masters, a major of study (e.g., a major in electrical engineering), a minor of study (e.g., minoring in French), or the like). The student information may also include a branch of military in which each student served, which may include the specific branch (e.g., army), a length of service (e.g., 5 years), a rank (e.g., corporal), discharge information (e.g., honorable or dishonorable discharge), or the like.

The SCO information may include any information related to the SCO. For example, the SCO information may include a list of tasks for which the SCO is responsible. The list of tasks may be generated automatically by the platform, manually generated by the user, or the like. The SCO information may also include a list of students assigned to the SCO. The SCO information may further include information regarding the SCO's history (e.g., previous work history, military service, or the like). The SCO information may further include a document or note associated with the SCO (e.g., a list of general responsibilities, an employment agreement, notes the SCO takes for himself, notes regarding the SCO generated by a supervisor, or the like). The SCO information may also include a calendar corresponding to the SCO. The calendar may include calendar entries associated with the SCO such as important events (e.g., graduation date, class signup dates), due dates (e.g., a calendar entry may include a due date and specific task due on that date), or the like. The calendar entries may be automatically generated by the platform, may be manually generated by the user, or any combination thereof.

In block 706, a user may access the platform using a user device. Users may include any users such as an SCO, a supervisor, a manager, an administrator, or the like. In some embodiments, the platform may provide functionality for students, and the user may include students. The user device may include any user devices such as a smartphone, a tablet, a laptop, a desktop, or the like. The user device may access the platform from any location so long as internet access is available. Each user may have a username and password which the user may provide to access the platform. To increase security of the platform, two-factor authentication may be required (e.g., a user may first log in using the username and password and may then enter a code that was texted to a phone associated with the user). The functionality of the platform that is available to the user may be based on the user's role within the platform. For example, certain functionality may be available to an SCO, other functionality may be available to supervisors, and yet other functionality may be available to system administrators.

In block 708, the server may receive input data from a user device. That is, a user may use the user device to provide data to the platform. This input data may include any information such as addition of a new student, creation of new semesters or blocks, information or documents associated with a student or SCO, or the like. The user data may further include input corresponding to an action to be performed by the platform including information usable to perform the action and a request to perform the action. For example, the action may include any actions such as adding or removing a student from a list of students, changing student information related to a student, adding or revising a document or note associated with a student or an SCO, adding or marking as complete a task to be performed by the SCO, creating an audit report, creating a new calendar entry, or the like. The input corresponding to the action to be performed may include parameters of the action (e.g., information to be included in a calendar entry or new task, information to be included in an audit report, a desired format of an audit report, or the like).

In block 710, the platform may perform an action based on the input. As mentioned above with reference to block 708, the action may include any action which the platform may perform. The action may be an action specified by a user (e.g., create a new calendar entry with specific information), may be an action automatically taken by the platform (e.g., updating student information when grades are released by a school), or any combination thereof.

In block 712, the database may be updated based on the action. For example, if the action is to add a new student, then the platform may update the information in the database to reflect the new student information. As another example, if a task is marked as completed, then the platform may update the information to reflect completion of the task.

In block 714, the platform may create a log entry in response to performance of the action and may add the log entry to a list of logs. The list of logs may be stored in the database or elsewhere within the system (e.g., a local memory of the server). The platform may be designed to create a log entry for each action performed by the platform or by a user. In some embodiments, the platform may be designed to create log entries for only certain actions. The platform may be designed to retain the list of logs for a predetermined period of time (e.g., 5 years, 10 years, or the like). The list of logs may be accessed by a user. In some embodiments, the list of logs may be sorted by a user. For example, a user may request a list of all logs associated with a specific student, may request a list of all logs over a predetermined period of time, or the like. In some embodiments, a user may be capable of hiding certain logs for various purposes, but the logs may remain stored in the database while hidden.

In block 716, the platform may generate output data to be transmitted to the user device for output or display by an output device of the user device (e.g., a touchscreen, display, speaker, or the like). The output data may be based on the action performed by the user. For example, if the action is to add a task to a list of tasks, then the output data may include a list of tasks with the new task included. As another example, if the action is to generate an audit report, then the output data may include a copy of the audit report. As yet another example, if the action is to upload a document, then the output data may include a notice that the document was successfully uploaded.

In block 718, the platform may identify a priority of each task in a list of tasks assigned to an SCO. The priorities of tasks may be identified when the task is created, some or all priorities may be identified or updated periodically or from time to time, or the like. The priorities may be identified by the platform, by a user, or some combination thereof. For example, the platform may identify a priority of each task as it is created or added based on the parameters of the task (e.g., a task to review courses in which students are enrolled may be set by the platform to have a relatively important priority). As another example, a user may provide a priority of each task, either as the task is added or after reviewing the task. As yet another example, the platform may set a priority for a task, and then the SCO may adjust the priority based on his knowledge.

In block 720, the platform may order a list of tasks. The tasks may be ordered by any parameters, and the platform may be designed with the parameters set or the parameters may be set by a user. For example, the tasks may be ordered by priority with the highest priority tasks at the top and the lowest at the bottom. As another example, the tasks may be ordered by due date with the closest deadlines at the top. As yet another example, the tasks may be ordered by task creation date with the oldest tasks at the top. As yet another example, the tasks may be ordered by a combination of due date and priority (e.g., tasks may be ordered by due date and tasks having the same due date are ordered by priority). The ordered list of tasks may be output via a display of the user device to help an SCO plan his or her time.

In block 722, the platform may detect a trigger event. Trigger events may include any event in response to which the platform is designed to take an action, such as sending an email. The platform may be designed to detect certain trigger events, and users may add new trigger events to the platform. Examples of trigger events may include a current date being within a predetermined quantity of days of an incomplete task, a student grade dropping below a threshold grade, a student dropping a course for which he is registered, or the like.

In block 724, the platform may take an action in response to detection of the trigger event. The platform may be designed to take certain actions in response to certain triggers, and users may add new actions to the platform. Example actions may include automatically generating and sending an email to the SCO, a supervisor, or any other individual or entity in response to a trigger event being detected. For example, an email may be sent to an SCO if a task that is due today has yet to be marked as completed. The content and format of the email may be predetermined by the platform, may be set by a user, or any combination thereof; for example, emails may have a predetermined format, and a user may adjust the predetermined format to suit his preferences. The content of these emails may be related to the trigger event and may include relevant information. For example, if a student's grade point average has dropped below a predetermined threshold then an email may be sent to the SCO that includes the student's name, the student's grade point average, a threshold grade point average, and reasons why the threshold grade point average was selected (e.g., to maintain a scholarship). In this way, an SCO is more likely to handle any issues as they arise than an SCO working without the platform.

As mentioned above, the platform may generate and save responses to audits. For example, if an audit is required at the end of each semester, the platform may automatically generate the audit(s) based on the required criteria (e.g., student name, student grade, expenses of each student, etc.). In some embodiments, the SCO may provide criteria and request an audit generation based on the specified criteria. For example, the SCO may select one or more student for which the audit will apply, identify a starting semester (or date) and an ending semester (or date), identify the type of logs or records that are desired to be included in the audit, identify one or more document type that is desired to be included in the audit, or the like. The platform may further store each audit in a memory such that it is accessible by the SCO at any future point in time.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” (and a phrase similar to “at least one of A, B, and C”) is used in the specification and claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for managing responsibilities of a school certifying official (SCO), the method comprising:
storing, on a server, information usable to host a platform for managing responsibilities of the SCO;
storing, on the server or in a memory, a database of stored data related to the responsibilities of the SCO, and including student information related to a plurality of students assigned to the SCO and SCO information related to the responsibilities of the SCO, the student information including a list of students assigned to the SCO that correspond to the plurality of students assigned to the SCO and student information associated with each student in the list of students, and the SCO information including a list of tasks to be completed by the SCO;
accessing, by a user, the platform using a user device that is separate from the server and in electrical communication with the server;
receiving, from the user device, input corresponding to an action to be performed by the platform, the action being related to at least one of the student information or the SCO information, and the input including any input information required for the platform to perform the action;
performing, by the platform, the action related to the responsibilities of the SCO;
updating, in the database, at least one of the student information or the SCO information in the stored data based on results of the action;
generating, by the platform, a log entry in response to performance of the action, and storing the log entry in a list of logs in the database; and
outputting, on the user device, output data related to completion of the action.

2. The method of claim 1, wherein the action includes at least one action from a plurality of actions including:
adding or removing at least one student from the list of students assigned to the SCO;
changing the student information related to at least one student from the list of students assigned to the SCO;
adding or revising a document or note associated with at least one student from the list of students assigned to the SCO;
adding or revising a document or note associated with the SCO; or
adding or marking as complete a task to be completed by the SCO from the list of tasks associated with the SCO.

3. The method of claim 2, wherein the platform is configured to perform each of the plurality of actions.

4. The method of claim 1, wherein the action includes creating an audit report to include at least a portion of the student information from the database associated with each student in the list of students.

5. The method of claim 4, further comprising receiving, from the user device, an identifier of information to be included in the audit report, wherein performing the action includes creating the audit report to include the identified information.

6. The method of claim 4, further comprising receiving, from the user device, format information corresponding to a desired format of the audit report, wherein performing the action includes creating the audit report to have the desired format.

7. The method of claim 1, wherein the student information includes at least one of student grades, classes in which each student is enrolled, scholarships awarded to each student, benefits assigned to each student, a document or note associated with at least one student, a program of study in which each student is enrolled, or a branch of military in which each student served.

8. The method of claim 1, wherein the SCO information includes at least one of the list of tasks to be performed by the SCO, a document or note associated with the SCO, or a calendar with a plurality of calendar entries associated with the SCO.

9. The method of claim 1, further comprising:
identifying, by the platform, a priority of each task from the list of tasks based on information associated with each task; and
ordering, by the platform, the list of tasks based on at least one of the identified priority or a due date of each task.

10. The method of claim 1, further comprising:
detecting, by the platform, a trigger event corresponding to a specific event; and
automatically generating and sending, by the platform, an email having a predetermined format and content identified by the SCO in response to detection of the trigger event.

11. The method of claim 1, further comprising automatically generating and sending, by the platform, an email having information corresponding to an open task and a due date of the open task when the due date of the open task is at least one of the present day or a previous day, wherein the list of tasks includes a due date and a status for each task.

12. A method for managing responsibilities of a school certifying official (SCO), the method comprising:
storing, on a server, information usable to host a platform for managing responsibilities of the SCO;
storing, on the server or in a memory, a database of stored data related to the responsibilities of the SCO, and including student information related to a plurality of students assigned to the SCO and SCO information related to the responsibilities of the SCO, the student information including a list of students assigned to the SCO that correspond to the plurality of students assigned to the SCO and student information associated with each student in the list of students, and the SCO information including a list of tasks to be completed by the SCO;
accessing, by a user, the platform using a user device that is separate from the server and in electrical communication with the server;
receiving, from the user device, input corresponding to an action to be performed by the platform, the action being related to at least one of the student information or the SCO information, and the input including any input information required for the platform to perform the action;
identifying, by the platform, a priority of each task from the list of tasks based on information associated with each task;
ordering, by the platform, the list of tasks based on at least one of the identified priority or a due date of each task;
performing, by the platform, the action related to the responsibilities of the SCO;
updating, in the database, at least one of the student information or the SCO information in the stored data based on results of the action; and
outputting, on the user device, output data related to completion of the action.

13. The method of claim 12, wherein the action includes at least one action from a plurality of actions and the platform is configured to perform each of the plurality of actions, the plurality of actions including:
adding or removing at least one student from the list of students assigned to the SCO;
changing the student information related to at least one student from the list of students assigned to the SCO;
adding or revising a document or note associated with at least one student from the list of students assigned to the SCO;
adding or revising a document or note associated with the SCO;
creating an audit report to include at least a portion of the student information from the database associated with each student in the list of students; or
adding or marking as complete a task to be completed by the SCO from the list of tasks associated with the SCO.

14. The method of claim 13, further comprising receiving, from the user device, an identifier of information to be included in the audit report and format information corresponding to a desired format of the audit report, wherein the action includes creating the audit report to include the identified information and to have the desired format.

15. The method of claim 12, further comprising:
detecting, by the platform, a trigger event corresponding to a specific event; and
automatically generating and sending, by the platform, an email having a predetermined format and content identified by the SCO in response to detection of the trigger event.

16. The method of claim 12, further comprising automatically generating and sending, by the platform, an email having information corresponding to an open task and a due date of the open task when the due date of the open task is at least one of the present day or a previous day, wherein the list of tasks includes a due date and a status for each task.

17. A system for managing responsibilities of a school certifying official (SCO), the system comprising:
a memory configured to store information usable to host a platform for managing responsibilities of the SCO and to configured to store plurality of students assigned to the SCO and SCO information related to the responsibilities of the SCO, the student information including a list of students assigned to the SCO that correspond to the plurality of students assigned to the SCO and student information associated with each student in the list of students, and the SCO information including a list of tasks to be completed by the SCO;
a user device configured to be used to access the platform, to receive user input, and to display output data; and
a server in electrical communication with the user device and the memory and configured to:
host the platform using the information stored in the memory,
receive input from the user device, the input corresponding to an action to be performed by the platform, the action being related to at least one of the student information or the SCO information, and the input including any input information required for the platform to perform the action,
perform the action related to the responsibilities of the SCO,
update at least one of the student information or the SCO information in the stored data based on results of the action,
generate a log entry in response to performance of the action, and storing the log entry in a list of logs in the database, and
generate the output data for display on the user device based on completion of the action.

18. The system of claim 17, wherein the action includes at least one action from a plurality of actions and the server is configured to perform each of the plurality of actions, the plurality of actions including:
adding or removing at least one student from the list of students assigned to the SCO;
changing the student information related to at least one student from the list of students assigned to the SCO;
adding or revising a document or note associated with at least one student from the list of students assigned to the SCO,
adding or revising a document or note associated with the SCO;
creating an audit report to include at least a portion of the student information from the memory associated with each student in the list of students; or
adding or marking as complete a task to be completed by the SCO from the list of tasks associated with the SCO.

19. The system of claim 17, wherein the server is further configured to:
identify a priority of each task from the list of tasks based on information associated with each task; and
order the list of tasks based on at least one of the identified priority or a due date for each task.

20. The system of claim 17, wherein the server is further configured to:
detect a trigger event corresponding to a specific event; and
automatically generate and send an email having a predetermined format and content identified by the SCO in response to detection of the trigger event.
